(19) United States
(12) Patent Application Publication
(10) Pub. No.: US 2026/0234867 A1
(43) Pub. Date: Aug. 13, 2026

(54) A METHOD FOR RECOVERING LIGNIN MICROPARTICLES FROM SPENT PULPING LIQUOR, A METHOD FOR PREPARING CARBONIZED LIGNIN, LIGNIN MICROPARTICLES, A COATING COMPOSITION, A RESIN, AN ELECTROCHEMICAL ENERGY STORAGE DEVICE CARBONIZED LIGNIN MICROPARTICLES, AND USE OF THE LIGNIN MICROPARTICLES AND THE CARBONIZED LIGNIN MICROPARTICLES

(71) Applicant: Teknologian Tutkimuskeskus VTT Oy, Espoo (FI)

(72) Inventors: Olesya FEARON, Espoo (FI); Anna KALLIOLA, Espoo (FI); Hanna KYLLÖNEN, Espoo (FI); Juha HEIKKINEN, Espoo (FI); Katri KONTTURI, Espoo (FI); Virpi SIIPOLA, Espoo (FI); Katariina TORVINEN, Espoo (FI); Chamseddine GUIZANI, Espoo (FI); Glen PAULS, Espoo (FI); Olli SORSA, Espoo (FI)

(21) Appl. No.: 19/153,562

(22) PCT Filed: Feb. 16, 2024
(86) PCT No.: PCT/FI2024/050063

§ 371 Date: Aug. 4, 2025

(30) Foreign Application Priority Data
Feb. 17, 2023 (FI) 20235198

(51) Int. Cl. D21C 11/00; B01D 61/02; B01D 61/14; B01D 69/02; C01B 32/05; C08H 7/00; C09D 197/00; H01M 4/583

(52) U.S. Cl. CPC D21C 11/0007; B01D 61/027; B01D 61/145; B01D 69/02; C01B 32/05; C08H 6/00; C09D 197/005; D21C 11/0042; H01M 4/583; B01D 2311/08; B01D 2325/20; C01P 2004/61; C01P 2006/12; C01P 2006/14; C01P 2006/40

(57) ABSTRACT

A method for recovering lignin microparticles from spent pulping liquor, the method comprising providing spent pulping liquor, rejecting lignin from the spent pulping liquor with a membrane filter with a cut-off value in the range of 500-2000 Da to obtain a first concentrate comprising the lignin and a permeate, dispersing the first concentrate into water or aqueous solution to obtain a first dispersion, rejecting lignin microparticles from the first dispersion with a membrane filter having a cut-off value in the range of 500-2000 Da to obtain a second concentrate comprising lignin microparticles and a permeate, and recovering the lignin microparticles, wherein at least 50% by volume of the lignin microparticles are non-fused and have a spherical shape and a diameter in the range of 1-50 μm.

### TECHNICAL FIELD

The present application relates to a method for recovering lignin microparticles from black liquor, to lignin microparticles, and to a coating, a resin and carbonized lignin microparticles comprising or obtained from the lignin microparticles. The present application also relates to a method for preparing carbonized lignin. The present application also relates uses of the lignin microparticles.

### BACKGROUND

Lignin is obtained from industrial pulping processes, such as kraft, soda or sulphite processes. It is estimated that 18 000 kt/a kraft lignin could be extracted globally. However, only 100 kt of kraft lignin is currently recovered. In the current kraft lignin recovery by acid precipitation, lignin isolation results in an excess use of chemicals and a production of waste in the form of fly ashes (mainly composed on Na₂SO₄ and Na₂CO₃). This current extraction method limits the applicability of kraft lignin and necessitate a post-treatment prior to use in most applications. Consequently, the final lignin-based products are expensive compared to fossil alternatives which limits their commercialization.

Kraft biorefineries are looking for the possibilities to valorise lignin, simultaneously chemical industries have a need for biobased aromatic chemicals. Lignin represents the highest source of biobased aromatics. However, the applicability of lignin product recovered by currently existing processes is limited due to non-uniform structure and aggregation during the recovery process that leads to low reactivity.

The recovery of lignin from black liquor is challenging. The black liquor contains relatively high content of inorganic salts. The inorganic salts and organic aliphatic and phenolic compounds present in the black liquor promote lignin aggregation and cluster formation forming “bridges” for microparticles agglomeration. This makes it difficult to separate and recover lignin, and especially to obtain lignin in a high quality form in high quantities.

Challenges in making lignin recovery process technology efficient include a cost of removing excess sulphur that is introduced in the chemical recovery cycle with addition of sulfuric acid used in the process. Sulphur must be removed or compensated by make-up NaOH which is added into the process. It is an even more significant cost factor than the cost of sulphuric acid. Despite the cost, problems with Na/S balance result in high dumping ash volumes that have a negative environmental impact.

Attempts to recover lignin have been based on approaches such as precipitation of lignin by acids or carbon dioxide, which however may result in further agglomeration of lignin microparticles and requires specific process equipment and introduction of substances such as sulphuric acid into the closed kraft pulping recovery cycle, which distorts the pulp mill's Na/S balance and is not desired.

The pulp and paper making processes are well optimised in terms of energy utilization and recycling of chemicals. In a state-of-the-art kraft pulp mill, the black liquor, rich in lignin, is used to produce energy in the recovery boiler and the cooking chemicals (Na, S) are recovered for reuse. The produced renewable energy is first used to cover the internal energy demands, and the excess is sold to the market. Currently, lignin can be recovered from black liquor by technologies such as LignoBoost (by Valmet), A+ recovery (by ANDRITZ), and LignoForce (by NORAM Engineering), which all use CO₂ precipitation and acid washing (with sulfuric acid H₂SO₄). Lignin recovery allows increase in pulp production capacity if the capacity of the recovery boiler has been a bottleneck in the process. However, even partial lignin recovery results in the formation of large quantities of fly ash that are disposed to landfills. In addition to the increased use of H₂SO₄, the conventional lignin recovery increases the use of make-up NaOH in the mill. The costs of these chemicals and the need of resolving the Na/S balance are the major challenges hindering the investing on kraft lignin recovery. The present method goes beyond the state of the art by developing a novel technology to recover kraft lignin in a way that will not interfere with the main pulping process or the chemical balance of the mill, and simultaneously provides lignin with a defined quality.

Molecular weight fractioning has been proven to be very challenging. Problems arise due to concentration polarization and membrane fouling. Therefore the prior art does not provide methods for obtaining lignin with small particle sizes.

Further the lignin applicability is limited due to its undefined structure. Typically, for the different end-use applications the recovered lignin needs to be modified to enhance the solubility, reactivity, or compatibility. Post-treating the recovered lignin into a form of lignin nanoparticles (LNPs) would enhance lignin utilisation in high value applications. LNPs have several advantages over the starting lignin material, such as higher surface area per mass unit, well-defined spherical shape, tuneable surface charge, as well as colloidal stability in aqueous media. Therefore, LNPs demonstrate better applicability and higher reactivity in some applications. LNPs are produced from already recovered lignin, mainly, by utilization of organic solvents (e.g. ethanol) and water, and applying relatively low lignin concentration as well as agitation/mechanical treatment with high energy demand. However, utilization of organic solvents does not follow the principles of green chemistry. Moreover, recovery of solvents and water requires a lot of energy that increases the carbon footprint and cost of the final product. Finally, LNPs have to be applied as a solution, otherwise lignin nanoparticles aggregate and form “films” during the drying phase.

It is desired to obtain methods for producing and recovering lignin with high quality and in high amounts and high purity. It is also desired to obtain a process which allow control over the properties of the produced and recovered lignin, such as molecular weight, shape, size, structure and other properties. It is also desired to obtain lignin products which are useful in a variety of end applications and enable producing new and enhanced end products.

### SUMMARY

A process was found to recover lignin from black liquor in the form of spherical microparticles with controlled size and shape. The lignin microparticles have excellent performance in several applications compared to commercial kraft lignin recovered by acid precipitation.

Furthermore, the present method makes the recovery of kraft or soda lignin more environmentally friendly. Production of lignin with a small size and defined spherical shape enhance the lignin applicability and processability during recovery due to its defined morphology.

Extracted lignin has a relatively low ash content which is beneficial from application point of view as well as from chemical recovery (no interference of Na/S balance) at the mill. The concept can be modified and upgraded depending on the final targets by different cut-offs of membranes or chemical addition to increase stability or to replace Na to H in lignin structure.

The present disclosure provides a method for recovering lignin microparticles from spent pulping liquor, the method comprising
providing spent pulping liquor, such as obtained from a soda and/or kraft process,
rejecting lignin from the spent pulping liquor with a membrane filter with a cut-off value in the range of 500-2000 Da to obtain a first concentrate comprising lignin and a permeate,
dispersing the first concentrate comprising lignin into water or aqueous solution, such as into acidified water or secondary condensate, to obtain a first dispersion,
rejecting lignin microparticles from the first dispersion with a membrane filter having a cut-off value in the range of 500-2000 Da to obtain a second concentrate comprising lignin microparticles and a permeate,
recovering the lignin microparticles, and
carrying out the method without precipitation of lignin, without emulsion solvent evaporation and without depolymerization of the recovered lignin, wherein
majority of the lignin microparticles have a spherical shape and a diameter in the range of 1-50 μm, determined by scanning electron microscopy (SEM) and/or by laser diffraction.

The present disclosure also provides lignin microparticles, wherein majority of the lignin microparticles have a spherical shape and a diameter in the range of 1-50 μm determined by scanning electron microscopy (SEM) and/or by laser diffraction, which lignin microparticles may be obtained by the method, wherein the lignin microparticles are unprecipitated with additional agents and not obtained by emulsion solvent evaporation, and the lignin is undepolymerized.

The present disclosure provides a method for preparing carbonized lignin, the method comprising
providing the lignin microparticles, and
carbonizing the lignin microparticles in a carbonization process by thermally treating the lignin microparticles at a carbonization temperature in the range of 500-2000° C. with a heating rate in the range of 0.1-10000° C./min.

The present disclosure also provides a coating composition and an object comprising a coating on a surface, the coating composition and the coating comprising the lignin microparticles.

The present disclosure also provides a resin comprising the lignin microparticles.

The present disclosure also provides carbonized lignin microparticles obtained from the lignin microparticles.

The present disclosure also provides use of the lignin microparticles for preparing a coating composition, for coating a surface of an object, for preparing a resin, and for preparing carbonized lignin.

The main embodiments are characterized in the independent claims. Various embodiments are disclosed in the dependent claims. The embodiments and examples disclosed herein are mutually freely combinable unless otherwise explicitly stated.

The present method for producing lignin microparticles (LMPs), such as spherical lignin microparticles, provides several benefits compared to lignin nanoparticle (LNP) production, while maintaining the benefits of microscale microparticles. In the present method the LMPs are formed already at the lignin recovery stage eliminating the acid precipitation step as well as the need for post-treatment of the recovered lignin. This consequently reduces the overall chemical load needed for extraction. Furthermore, organic solvents are not required.

The present lignin microparticles can be utilized as components for example in coating formulations, phenol formaldehyde resins and other applications. However, each application has different requirements for lignin properties. Consequently, to boost lignin commercialization, it is important to understand the interplay of lignin structure and performance in different end-uses.

The present method is a simple method for producing and recovering lignin microparticles with high quality and high purity in high amounts without additional chemicals and method steps, and the method allows control over the properties of the produced and recovered lignin microparticles, such as molecular weight, shape, size, structure and other properties. It is also possible to obtain lignin products which are useful in a variety of end applications and enable producing new and enhanced end products. Especially it is possible to obtain lignin microparticles which are not prone to agglomerate.

### BRIEF DESCRIPTION OF THE FIGURES

FIG. 1 shows an example of a simplified process scheme for the recovery of softwood (SW) and hardwood (HW) kraft lignin microparticles. Step 1 is an ultrafiltration concentration, step 2 is first diafiltration and step 3 is second diafiltration.

FIG. 2 shows a determined particle size distribution of the present lignin microparticles compared to reference kraft lignin microparticles.

FIG. 3 shows examples of A) conductivity (left) and pH (right) changes during the recovery process disclosed in FIG. 1 (Feed1=SW black liquor), and B) molecular weight (weight average molecular weight, Mw) evolvement during softwood kraft lignin recovery by membrane.

FIG. 4 shows SEM images of hardwood lignin microparticles recovered by the present method and dried by spray drying. FIG. 4A has a magnification of 225 x and FIG. 4B has a magnification of 1.05K x.

FIG. 5 shows SEM images of softwood kraft lignin microparticles recovered by membrane and dried by spray drying. FIG. 5A has a magnification of 143 x and FIG. 5B has a magnification of 3.53K x.

FIG. 6 shows SEM images of reference kraft lignin microparticles, which are recovered by LignoBoost process. FIG. 6A has a magnification of 200 x and FIG. 6B has a magnification of 50K x.

FIG. 7 shows FTIR spectres determined from the present SW kraft lignin microparticles and from reference SW kraft lignin.

FIG. 8 shows mass loss, mass loss rate, and conversion level as a function of carbonization temperature for reference kraft ligninparticles (left) and the present kraft lignin microparticles (right)

FIG. 9 shows stereomicroscope images of reference kraft lignin particles (9A) and the present kraft lignin microparticles (9B) after carbonization at 10° C./min up to 1000° C.

FIG. 10 shows SEM images of reference kraft lignin particles before (10A) and after carbonization at 10° C./min up to 1000° C. (10B).

FIG. 11 shows SEM images of the present kraft lignin microparticles before (11A) and after carbonization at 10° C./min up to 1000° C. (11B).

FIG. 12 shows SEM-EDX images of the present kraft lignin microparticles showing the homogenous Na-dispersion (right top image).

FIG. 13 shows SEM-EDX point analysis of the present kraft lignin microparticles after carbonization showing surface agglomerates of Na-oxides.

FIG. 14 shows thermogravimetric mass loss as a function of time and temperature for the reference lignoboost kraft lignin particles (dashed line) and the present kraft lignin microparticles (solid line) after carbonization at 10° C./min up to 850° C. in argon and subsequent activation with CO₂ at the same temperature.

FIG. 15 shows wooden blocks coated with reference lignin (conventional softwood kraft lignin) and the present softwood kraft lignin microparticles.

FIG. 16 shows comparison of reference resin (16A) and a resin prepared with the present kraft lignin microparticles (16B).

FIG. 17 shows SEM-EDX images of the KLMP sample showing Na-mapping on particles.

FIG. 18 shows SEM images of the KLMP during various steps of AC synthesis: before carbonization (18A), after carbonization (18B) and after carbonization and washing (18C).

FIG. 19 shows STA-MS analysis of untreated (shows activation) and pre-treated KLMP sample. FIG. 19A: the present KLMP, 19B: commercial LignoBoost KL.

FIG. 20 shows N₂ adsorption isotherm for the present KLMP (“VTT-KLMP”) carbonized at 1200° C. and subsequently acid washed.

FIG. 21 shows pore size distribution and cumulative pore volume in the present KLMP (“VTT-KLMP”) carbonized at 1200° C. (2D-NLDFT).

FIG. 22 shows adsorption of CO₂ vs V of narrow micropores in the present KLMP (“VTT-KLMP”) carbonized at 1200° C.

FIG. 23 shows specific delithiation capacity at different delithiation rates for directly carbonized VTT-KLMP, pre-treated VTT-KLMP, and commercial hard carbons (MTI and MSE).

FIG. 24 shows lithiation/delithiation profiles of the first cycle for the directly carbonized VTT-KLMP and pre-treated VTT-KLMP. In b) and c) the profile has been plotted as voltage differential for the directly carbonized VTT-KLMP and pre-treated VTT-KLMP, respectively.

FIG. 25 shows content of inorganics and sulfur in VTT-KLMP and pre-treated VTT-KLMP

FIG. 26 shows SEM images of hard carbon particles carbonized at 1200° C. from a) untreated VTT-KLMP and b) pre-treated VTT-KLMP.

FIG. 27 shows untreated and pre-treated VTT-KLMP samples carbonized at 1200° C. The glass vials were vigorously shaken and left to settle. The untreated VTT-KLMP shows a much higher proportion of fines which tend to coat the glass walls compared to the pre-treated ones. Handling the pre-treated carbon powder would be easier, with lower risks related to fine powder inhalation or ignition.

FIG. 28 shows the morphology of commercial LignoBoost® Kraft lignin and VTT-KLMP after pre-oxidation step.

FIG. 29 shows hydrogen mobility in commercial LignoBoost® kraft lignin, VTT-KLMP and pre-treated VTT-KLMP.

FIG. 30 shows STA-MS analysis of untreated (30A, shows activation) and pre-treated VTT-KLMP sample (30B).

### DETAILED DESCRIPTION

In this specification, percentage values, unless specifically indicated otherwise, are based on weight (w/w, by weight, or wt %). If any numerical ranges are provided, the ranges include also the upper and lower values. The open term “comprise” also includes a closed term “consisting of” as one option. The sizes or diameters disclosed herein, unless specifically indicated otherwise, refer to the smallest diameter, and may be presented as average diameter, volume-weighted diameter, volume-average diameter or number-average diameter and may be determined microscopically and/or by laser diffraction, preferably by using a dedicated software. The reference kraft lignin as used herein refers to kraft lignin obtained by the conventional acid precipitation based recovery process, such as by LignoBoost process.

Lignin recovery by membrane were done for hardwood and softwood black liquor. Lignin obtained by the present method is alkali lignin with bonded Na in the structure, defined shape and size. The present lignin microparticles, which may be also called as lignin microspheres, have preferably a size, i.e. a diameter, of majority or substantially all of the particles in micrometer range, such as in the range of few micrometres or tens of micrometers, preferably less than 100 micrometers.

The present application provides a method for recovering lignin microparticles from spent pulping liquor, such as black liquor. The method may be specified as a method for recovering lignin in (micro) particle form, in spherical (micro) particle form and/or in microbead form, from spent pulping liquor. The method may be carried out as a batch process. The method comprises providing the spent pulping liquor, which may be black liquor, which may be obtained from a soda process and/or a kraft process. The spent pulping liquor can also be obtained from soda cooking of bark, while being rich in tannin and lignin. Preferably the spent pulping liquor is directly obtained from the process.

The present methods are explained with reference to black liquor from kraft process, but other suitable sources of spent pulping liquor may be applied in a similar manner. The spent pulping liquor, such as black liquor, may have a dry matter content in the range of 20-50% by weight. The black liquor may be obtained from a digester, from an evaporator and/or from any step between a digester and an evaporator.

The black liquor contains relatively high content of inorganic salts. For example, sodium carbonate and sodium sulphate may together constitute around 15% of the dry mass. The inorganic compounds present in the black liquor promote lignin aggregation and cluster formation by reducing the colloidal stability of the lignin particles during their formation; presence of excess of salt ions causes screening of the inherent electrostatic repulsion between lignin particles (induced mainly by anionic carboxyl groups present in the lignin structure), inducing aggregation of the particles.

In the present invention it was found out that removal of inorganic compounds and compounds that pass through a membrane with cut-off value of about 1000 Da will dramatically decrease the ionic strength of the system, enhancing the colloidal stability, thus enabling controlling lignin particle formation. By changing an ionic strength of the system it was possible to prevent lignin aggregation. A cut-off value, such as 1000 Da, may be defined as the lowest molecular weight (in Daltons) at which greater than 90% of a solute with a molecular weight of 1000 Da is retained/rejected by the membrane. In tests also higher molecular weight compounds were found in the permeate. The permeate can be also called as a filtrate The permeate contains small molecules, which may be ionized, including inorganic and organic compounds, such as aliphatic acids and lignin with small particle size or molecular weight.

The method comprises rejecting lignin from the spent pulping liquor with a membrane filter with a cut-off value in the range of 500-2000 Da, which may comprise passing the liquid of the black liquor through a membrane filter with a cut-off value in the range of 500-2000 Da, to obtain a first concentrate comprising lignin, and a permeate. The rejected lignin, i.e. the lignin in the first concentrate is the lignin of interest in particle form, which is to be recovered, while lignin with low molecular weight passes the membrane. This step may be called as membrane concentration. The cut-off value may be in the range of 1000-2000 Da, or 1000-1200 Da. The cut-off value may be provided by a membrane provider or manufacturer, and it may be a range, such as the 1000-1200 Da. It may be presented as a nominal molecular weight value, which is defined as the minimum molecular weight of a solute that is 90% retained by the membrane. The same cut-off values may be used in the other steps as well.

The first concentrate is to be retained and/or recovered, and it is dispersed into water or aqueous solution for further steps. The water may be purified water, such as distilled water and/or deionized water. The aqueous solution may be for example acidified water or it may comprise secondary condensate from the pulping process and/or plant. The dispersing into water or aqueous solution may be also considered or called as washing. In the following dispersing steps similar water or aqueous solution may be used, and it may be desired to use even more pure water or aqueous solution in the further dispersing steps.

The processes involving dispersing the concentrates into water or aqueous solution are part of diafiltration process. The dispersing may be also considered as diluting and/or washing, and these terms may be used interchangeably. Diafiltration in general is a process using a semipermeable membrane, typically ultrafiltration membrane, to separate molecules based in size, and it involves adding back a different buffer or solvent after the filtration. The sample is preferably returned back to the original volume. The cycle can be repeated until the sample reaches a targeted level or replacement with the new buffer or solvent, and/or until the recovered lignin has desired properties. The first, second and any further concentrate may be a concentrated dispersion of solids rather than a (dry) filter cake, so it can be redispersed or diluted without problems. The dispersing may be facilitated by the flow and/or turbulence of the added water or aqueous solution, and/or by using suitable mixing means.

The method comprises dispersing the first concentrate comprising lignin into water or aqueous solution to obtain a first dispersion comprising lignin, and rejecting lignin microparticles from the first dispersion with a membrane filter having a cut-off value in the range of 500-2000 Da, which may comprise passing the liquid of the first dispersion comprising lignin through a membrane filter having a cut-off value in the range of 500-2000 Da, to obtain a second concentrate comprising lignin microparticles and a permeate. The membrane filter used in the filtering step may be the same as used in the previous filtering step, or it may be different. The same cut-off values may be applied. This step may be also considered or called as diluting and/or washing.

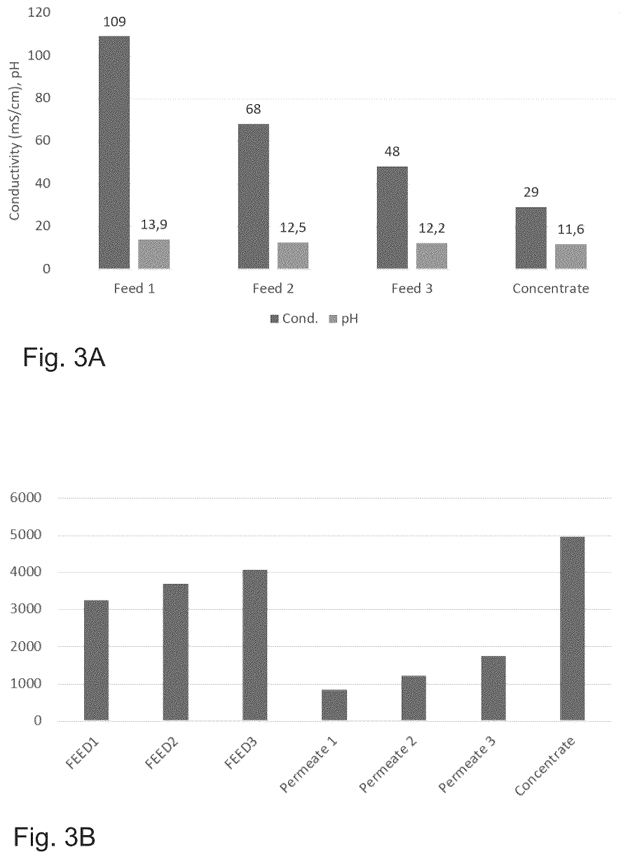

The method may comprise recovering the lignin microparticles from the second concentrate comprising lignin microparticles. However it may be desired to carry out at least one further dispersing, diluting or washing step, and at least one further filtering step. As can be seen from FIG. 3B, the molecular weight of the lignin increases in each step indicating progressing particle formation during the process.

In one embodiment the method comprises
dispersing the second concentrate comprising lignin microparticles in water or aqueous solution to obtain a second dispersion.,
rejecting lignin microparticles from the second dispersion with a membrane filter having a cut-off value in the range of 500-2000 Da, which may comprise passing the liquid of the second dispersion comprising lignin microparticles through a membrane filter having a cut-off value in the range of 500-2000 Da, such as in the range of 1000-2000 Da, or 1000-1200 Da, to obtain a third concentrate comprising lignin microparticles and a permeate, and
recovering the lignin microparticles from the third concentrate comprising lignin microparticles. Also this step may be considered or called as washing and/or diluting.

The passing a dispersion liquid through a membrane filter results in dividing the dispersion into a permeate and concentrate (retentate), and may be facilitated by using pressure. The expression “rejecting” used herein refers to dividing, retaining, recovering and/or separating lignin microparticles from a source, such as from the spent pulping liquor or from any of the dispersions, resulting in rejecting or separating the lignin into one fraction and separating flowthrough liquid and small molecules into other fraction, which is the permeate. One or more suitable means for providing pressure may be provided and used, such as one or more pumps, a source of pressure, and/or other applicable devices. The water or aqueous solution used in the dispersing/washing may be provided as pressurized, or may be pressurized. A pressure for example in the range of 6-10 bar may be used, but this depends on factors such as the used solution/dispersion, membrane cut off, crossflow velocity etc. A pressure in the range of 6-8 bar was found suitable in most cases, such as for the used cross-rotational filter. One or more pumps may be also provided and used in the dispersing steps, such as for providing water or aqueous solution for dispersing the concentrate/retentate and/or for feeding the concentrate to another container. This redispersing may be carried out in a separate container, such as a feed tank. The concentration of membrane-permeable microsolutes in the feed tank decreases over time, and the final product may be obtained directly in the feed reservoir when operation is terminated.

The filter may comprise a filter assembly or a module comprising a housing, and it may have a controllable rotor and/or an inner volume in a housing. The filter may comprise adjustment and/or measurement means for pressures in and out, for temperature, for rotor speed, for feed flow rate and/or for flux. In one embodiment the filter is a cross-rotational filter. A cross-rotational filter can create a high crossflow and turbulence on the membrane surface contained in the filter with special rotors leading to fouling reduction. The filter, such as the cross-rotational filter, may comprise two filter membranes, and it may have one or more rotors, for example between the membranes, which rotors may be connected or connectable to an actuator to rotate the rotors and to control the ration speed of the rotors. The concentrate may be formed in one or more inner volumes in a casing. Using such a filter assembly enables controlling and scaling the process, especially controlling the formation of the concentrates and redispersing thereof. For example the filter may be upscaled for industrial scale and/or downscaled to laboratory scale.

The membrane filter may be also called a membrane or a filter membrane. In one embodiment the membrane filter comprises a polymeric membrane filter, which are stable in acid and caustic solutions and tolerate pressure and were found especially suitable for the present cross-rotational filters. On the other hand for example ceramic membrane filters may be used for different filter setups, assemblies and/or installations. The polymeric membrane may be organic polymer membrane, such as synthetic or semi-synthetic organic polymer, such as selected from cellulose acetate, cellulose nitrate (collodion), (mixed) cellulose esters, polysulfone, polyethersulfone, polyamide (nylon), polycarbonate, polypropylene, polyvinylidene chloride (PVC) and polytetrafluoroethylene (Teflon), preferably a polyethersulfone membrane filter, which was found performing well in tests and which is thermally stable, durable and resistant to acidic and alkaline solutions and provides high filtering capacity, i.e. high flux. These membrane filters may be used in a cross-rotational filters or in other suitable filter assemblies.

The method may be carried out using a system setup comprising one or more filter, such as a series of two or more filters, such as three filters, which may be connected together and/or which are used in sequential order, one filter per one filtering step. The concentrate obtained from one filter, which may be flowable, may be conveyed and/or applied to another filter, preferably after dispersing into water or aqueous solution to substantially restore the original volume.

In one embodiment the aqueous solution comprises secondary condensate. A secondary condensate, which can be obtained from a secondary condenser of an evaporation plant, either directly or as processed, such as purified, was found suitable in some cases for the present process, especially for washing the black liquor in the first step. The secondary condensate may be pure enough, or can be easily purified to a suitable degree, and can be obtained from a pulping plant thus enabling recycling of water. More particularly the secondary condensate may be a kraft secondary condensate, and it may be available at the location wherein the black liquor is obtained.

The third concentrate may be recovered and the lignin microparticles may be recovered from the recovered third concentrate. For example the third concentrate may be recovered from the used filter and/or filter assembly, or from a feed tank or other container. The concentrate may be further processed, such as applied to another filter, to evaporating, to spray drying and/or to other step for further dewatering, washing, collecting and/or for other processing.

The temperature in a filtration step can be maintained at a moderate level, so temperatures above 80° C. are not required or even desired, as they will effect on the organic compounds in the black liquor, for example by softening lignin microparticles or causing their aggregation. This enables using a wider variety of membranes and it also has an impact to the properties of the lignin. For example the desired shapes, sizes and structures of the lignin microparticles are better formed and maintained. In one example the passing through a membrane filter is carried out at a pressure in the range of 6-8 bar and/or at a temperature in the range of 55-70° C., such as in the range of 55-60° C.

In one embodiment the dispersing, diluting and/or washing is carried out to obtain a dispersion with equal or substantially equal volume to the volume of the black liquor before filtering and/or equal or substantially equal volume to the volume of the previous dispersion. This may be for example 80-120% of the volume of the black liquor or previous dispersion before filtering, such as 90-110%, preferably about 100%.

The method may comprise recovering the permeate from one or more of the filtering steps and recovering the one or more substances from the permeate and/or recovering lignin having a molecular weight below the cut-off value of the filter, i.e. lignin passing the filter, preferably by nanofiltration. Such substances may be used for other purposes, for example the inorganic compounds may be recycled, and/or the low molecular weight lignin may be utilized directly to resin formulations, such as epoxy or alkyd resins, as well as utilized by chemical industries for further synthesis in chemicals production.

Recovering the lignin microparticles from a concentrate, such as from the second concentrate, from the third concentrate or from a further concentrate, refers to separating and/or harvesting the lignin microparticles from the concentrate, for example as a final product or as an intermediate product, which is to be further processed. The recovered lignin microparticles may be provided for further use and/or they may be packed, stored and transported to final use or further processing, such as for preparing products discussed herein.

The preparation of the present lignin microparticles may be carried out in the absence or without most prior art method steps and/or agents, and the obtained microparticles may lack prior art additives and/or modifications. In one embodiment the method comprises carrying out the method without precipitation of lignin, for example without precipitation with carbon dioxide and/or acid; without decreasing pH of the black liquor and/or any of the dispersions, such as with added chemical, such as without substantially decreasing the pH by more than 2 pH units, without hydrolysis of lignin, without enzymatic digestion of lignin, without emulsion solvent evaporation, without chemical derivatization of lignin, such as with added chemical, for example acetylation, without adding other fibers, fibrils and/or polymers, fillers, binders and/or the like additional agents, without carbonizing the lignin particles, and/or without depolymerization of the recovered lignin. When one or more, or all, of such process steps or conditions are avoided, such as adding chemicals or agents is avoided, it is possible to obtain lignin microparticles with desired properties, as discussed herein. The obtained, such as recovered, lignin microparticles are thus preferably not treated with additional chemicals or agents and/or enzymes and/or mechanical treatments, such as unprecipitated (non-precipitated) with additional agents, unhydrolyzed, enzymatically undigested, undepolymerized, underivatized, uncompacted and/or uncrushed and/or unground. The obtained lignin microparticles are uncarbonized, as they are not carbonized in the preparation and/or recovery process, but they can be carbonized in a further process, and the carbonized lignin microparticles may exhibit the other properties disclosed in previous. The lignin microparticles may be obtained directly from the filtering by membrane, such as obtained directly from a concentrate obtained from the method. The lignin microparticles may be obtained directly from spent pulping liquor by molecular fractioning and washing by the present method.

From the present process lignin microparticles can be obtained and/or recovered, wherein the majority of the microparticles have a spherical shape and a diameter in the range of 1-50 μm, such as in the range of 1-30 μm or 1-20 μm, for example in the range of 2-10 μm, 2-8 μm or 2-5 μm, determined by scanning electron microscopy (SEM) and/or by laser diffraction analysis.

The particle size and distribution of lignin microparticles can be determined by using any suitable particle size analyser, such as ones based on laser diffraction, and preferably by using a dedicated software, which is arranged to calculate and output the desired results. The particle size and distribution is preferably determined by using both electron microscopy, such as SEM, and laser diffraction analysis. The laser diffraction analysis or method can be carried out by using a suitable laser diffraction analyzer or apparatus, and may be carried out in liquid suspension, such as in aqueous suspension. The laser diffraction apparatus may have a dedicates software which may provide desired measurement results.

Because the light energy recorded by the detector array is proportional to the volume of the particles, laser diffraction results are intrinsically volume-weighted. This means that the particle size distribution represents the volume of particle material in the different size classes. This is in contrast to counting-based optical methods such as microscopy or dynamic image analysis, which report the number of particles in the different size classes. That the diffracted light is proportional to the particle's volume also implies that results are assuming particle sphericity, i.e. that the particle size result is an equivalent spherical diameter. The equivalent spherical diameter of an irregularly shaped object is the diameter of a sphere of equivalent volume.

The particle size (diameter) distribution may be presented with percentile values, which are statistical parameters that can be read directly from the cumulative particle size distribution. They indicate the size below which for example 10%, 50% or 90% of all particles are found, preferably determined by volume. In one example the particles are presented with median volume-weighted diameter (D₅₀), which is derived from the cumulative curve, and represents the particle diameter separating the upper 50% of the data from the lower 50%. The particle size (diameter) distribution may be also presented with D₁₀ and D₉₀ values, or with combinations thereof. Still another option is to present span obtained from the distribution values, which gives a measure of the width of the particle size distribution. The span is calculated as [D₉₀-D₁₀]/D₅₀.

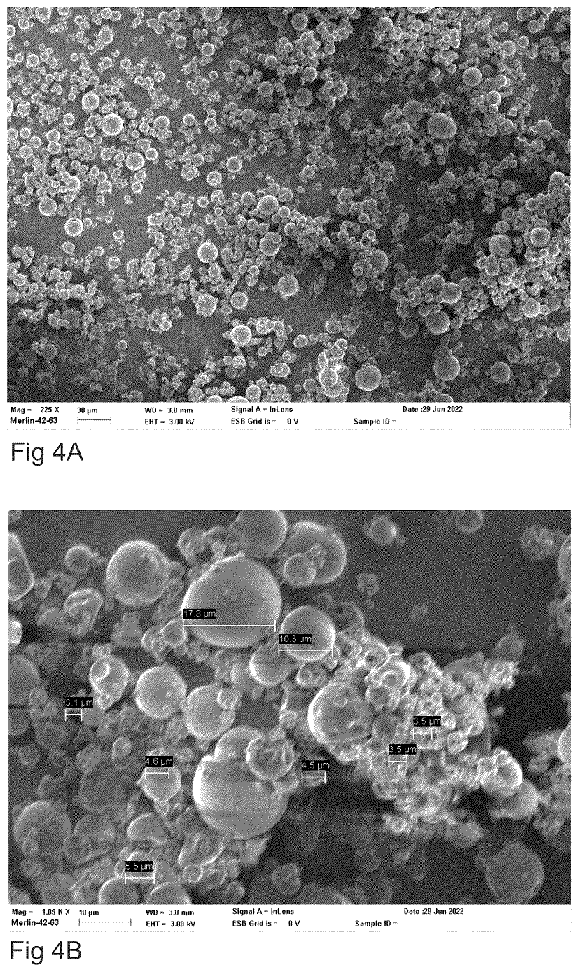

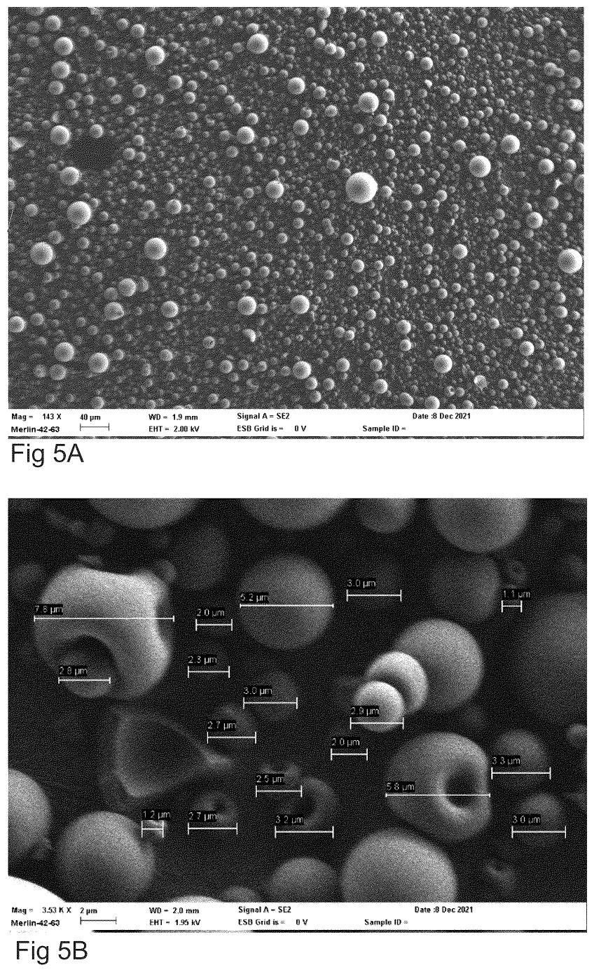

In the tests the lignin microparticle diameters were mostly in the range of about 1-18 μm, as can be seen from FIGS. 4B and 5B, but the average or mean diameter is usually in the range of 5-15 μm, 2-20 μm, 2-10 μm, or 1-8 μm, even 2-5 μm. The median volume-weighted diameter (D₅₀) of the lignin microparticles determined by laser diffraction may be also in said ranges.

The majority may refer to at least 50%, to at least 60%, to at least 70%, to at least 80%, to at least 90%, or to at least 95%, which may be determined by volume or by number. Preferably majority of the lignin microparticles have a diameter in the disclosed range, preferably determined by laser diffraction method. Regarding the shape, majority, or preferably all or substantially all of the lignin microparticles have the spherical shape, for example at least 80%, at least 90% or at least 95% have the spherical shape. The percentages and percentiles may refer to number of the microparticles (by number) or to volume of the microparticles (by volume). The shape can be determined by electron microscopy. In embodiments the percentile particle diameter distribution, determined by laser diffraction, comprises D₁₀ in the range of 2-3 μm, D₅₀ in the range of 5-15 μm and/or D₉₀ in the range of 90-100 μm. In one example D₁₀ of the softwood lignin microparticles is in the range of 2.2-2.6 μm, D₅₀ of the softwood lignin microparticles is in the range of 8-12 μm and/or D₉₀ of the softwood lignin microparticles is in the range of 95-99 μm. In one example at least 90% by volume of the particles are in the diameter range of 0.1-99.9 μm, determined by laser diffraction.

In one embodiment majority of the lignin microparticles have a spherical shape determined by electron microscopy and the percentile particle diameter distribution, determined by laser diffraction, comprises D₁₀ in the range of 2-3 μm, D₅₀ in the range of 5-15 μm and/or D₉₀ in the range of 90-100 μm.

The span of the lignin microparticles may be in the range of 5-20, such as 7-13 or 9-10, such as about 9.5. In general softwood lignin may yield smaller particles compared to hardwood lignin.

The obtained lignin microparticles have homogenous structure, such as inner structure, i.e. they are not hollow. This is a result of the present preparation method, wherein the lignin microparticles are obtained from spent pulping liquor by the present molecular weight fractioning. This method also causes the other properties discussed herein, such as the shape, size and distribution, and the ability to bind sodium.

### Importance of Shape and Size

Particles with defined morphology gives the possibility to control properties that are difficult to achieve with irregular, heterogeneous geometries. Such properties relevant to particulate systems are packing density, color, strength and transport (mass, heat). The morphologies of particles affect the binding forces that hold them together and their ability to form aggregates. The binding forces between particles are affected by their size and shape, which again will affect the properties of particle assemblies.

Particles with rough surfaces are more prone to aggregate due to attractive van der Waals interactions and the particles may be in a primary minimum preventing dispersion upon decrease in ionic strength. However, if colloids are attached on the asperities of rough surfaces, both theoretical and experimental results show that they may be released upon lowering of the ionic strength, demonstrating the importance of surface heterogeneity on colloidal stability.

The formation of spherical particles by lignin was still not fully understandable or discovered. Lignin has an intrinsic tendency for assembly into spherical particles that minimize the surface area in contact with the non-solvent phase. For example, acidification of an alkaline lignin solution leads to precipitation, and the precipitation continues to an irregular network structure and inevitable sedimentation, since acidification protonates the charged groups on lignin, preventing electrostatic stabilization of the particles.

In the case of membrane recovery of lignin by diafiltration it is possible to remove free inorganic elements, mainly sodium, small molecular weight organic molecules, such as aliphatic acids, lignin, carbohydrates etc. It was recognized, that to keep spherical microparticles it is very important to control interfacial interactions. Lignin recovery by membranes with simultaneous diafiltration is able to decrease the ionic strength of the system and therefore keep lignin in spherical form. Lignin with higher molecular weight forms spherical microparticles with smaller sizes. This phenomenon may be due to increased hydrophobic interactions. During lignin recovery by membranes, small molecular weight lignins go through membranes to permeate and higher molecular weight lignin stays in the targeted fraction. Also, an increase in molecular weight of lignin was detected after membrane recovery. Ionic strength directly controls the distance over which electrostatics can contribute to particle stability. A small amount of salt can have a major effect on the distances over which repulsive particle-particle interactions can be felt. Ionic strength is directly related to the concentration of small ions in solution.

Therefore, the formation of spherical lignin microparticles from black liquor is a combination of several factors, including decreasing ionic strength of the system by removing small ions in solution, which keeps microparticles stable; high molecular weight of lignin which forms smaller microparticles; and no protonation of charged group which allows keeping microparticles electrostatically stable.

It may be desired to further concentrate and/or dewater the obtained lignin microparticles. The dry solids content of the concentrate of lignin microparticles may be increases by evaporating. A concentrate of lignin microparticles can be dried by a freeze-drier, which however is not economically feasible, or by spray drying. Spray drying of lignin particle concentrate is working well. However, common press drying is not possible for the present recovered lignin concentrate. Therefore lignin concentrate may be used as it is, for example for coatings or for resin preparation, or may be dried through spray drying. In one embodiment the method comprises drying or dewatering the recovered lignin microparticles, such as by spray-drying. The lignin microparticles may be dried to a moisture content of 20% by weight or less, such as 10% by weight or less. The moisture content may be in the range of 0-20% by weight, 0-10% by weight, or 1-10% by weight. The lignin microparticles may be provided at this moisture content.

In one embodiment the method comprises recovering the lignin microparticles by spray-drying. This can be done from the second concentrate or from the third concentrate. The concentrate is dried in the spray drying, as discussed in previous.

The lignin microparticles may comprise phenolic functionalities, more particularly in form of phenolic OH groups, and aliphatic OH groups, on the surfaces of the lignin microparticles. Such groups may have an impact to the formation of lignin microparticles, for example to the shape and/or size. The phenolic functionalities can bind inorganics, such as sodium, thus enabling formation of sodium deposit on the surface of the microparticles. The functional groups in the lignin microparticles can be detected and quantitatively determined by using method known in the art, such as gas chromatography, UV-spectroscopy, ¹H, ¹³C and/or ³¹P NMR spectroscopy, FTIR spectroscopy, acid number determination, and non-aqueous and aqueous potentiometry. The lignin bound sodium and/or other inorganic substances can be detected by Scanning Electron Microscopy with Energy Dispersive X-Ray Spectroscopy (SEM-EDX) and quantified by Inductively coupled plasma atomic emission spectroscopy (ICP-EOS). The lignin microparticles, especially SW microparticles, may comprise 2.0 mmol/g or more aliphatic OH groups, such as 2.3 mmol/l or more, for example up to 3.0 mmol/g, determined by ³¹P NMR.

In one embodiment the lignin microparticles comprise sodium bound to lignin via phenolic groups or phenolates (phenolic functionalities), such as in the form of sodium phenolate. Under alkaline conditions, such as at pH of 11 or more, the phenolates can bind sodium thus enabling the formation of sodium deposit on the surface of the microparticles. The bound sodium is mainly on the surface of the lignin microparticles. The sodium may be present in organic form and/or in inorganic form.

It was found out that the sodium derived from the Kraft lignin could act as an activator of lignin, which enabled obtaining activate carbon particles with a low amount of activator, preferably without adding activator separately.

The initial highly dispersed state of the Na-based activating chemicals in the lignin microparticles as well as the Na form and/or state in the lignin including phenolate and mineral forms, such Na-carbonate (Na₂CO₃), Na-hydroxide (NaOH), and/or Na-sulphate (Na₂SO₄), enabled using a low ratio of activator/lignin (IR<0.25) compared to prior art chemical activation protocols for which IR>1. The inorganic forms of Na, such as NaOH and Na₂CO₃, can act as chemical activators during high temperature carbonization, leading to the gasification of the carbon surface and the creation of porosity.

The sodium content in the lignin microparticles may be in the range of 3-10% by weight, such as 5-9% by weight. The lignin microparticles may not substantially contain free sodium, as it may have been washed off during the preparation process. The lignin microparticles with bound sodium exhibit thermoset properties as the thermal motion is reduced.

One example provides lignin microparticles, wherein majority of the lignin microparticles have a spherical shape and a diameter in the range of 1-50 μm, such as in the range of 1-20 μm, determined by scanning electron microscopy (SEM) and/or by laser diffraction, comprising sodium bound to lignin via phenolic groups, such as in the form of sodium phenolate, and/or comprising sodium deposit (mainly) on the surface of the microparticles.

One example provides a method for recovering lignin microparticles from spent pulping liquor, the method comprising
providing spent pulping liquor,
rejecting lignin from the spent pulping liquor with a membrane filter with a cut-off value in the range of 500-2000 Da, to obtain a first concentrate comprising lignin and a permeate,
dispersing the first concentrate comprising lignin into water or aqueous solution,
rejecting lignin microparticles from the first dispersion with a membrane filter having a cut-off value in the range of 500-2000 Da to obtain a second concentrate comprising lignin microparticles and a permeate,
recovering the lignin microparticles, wherein
majority of the lignin microparticles have a spherical shape and a diameter in the range of 1-50 μm determined by scanning electron microscopy (SEM) and/or by laser diffraction and/or
wherein the lignin microparticles comprise sodium bound to lignin via phenolic groups, such as in the form of sodium phenolate, and/or comprise sodium deposit (mainly) on the surface of the microparticles.

The lignin microparticles have a high surface area, which may be calculated as total area of the particles divided by the total weight. In one embodiment the lignin microparticles have a specific surface area of 500 000 m²/kg or more, such as 700 000 m²/kg or more, for example 750 000 m²/kg or more, for example up to 900 000 m²/kg, or up to 800 000 m²/kg. The specific surface area may be determined by laser diffraction, and it may be provided by the software of the laser diffraction apparatus.

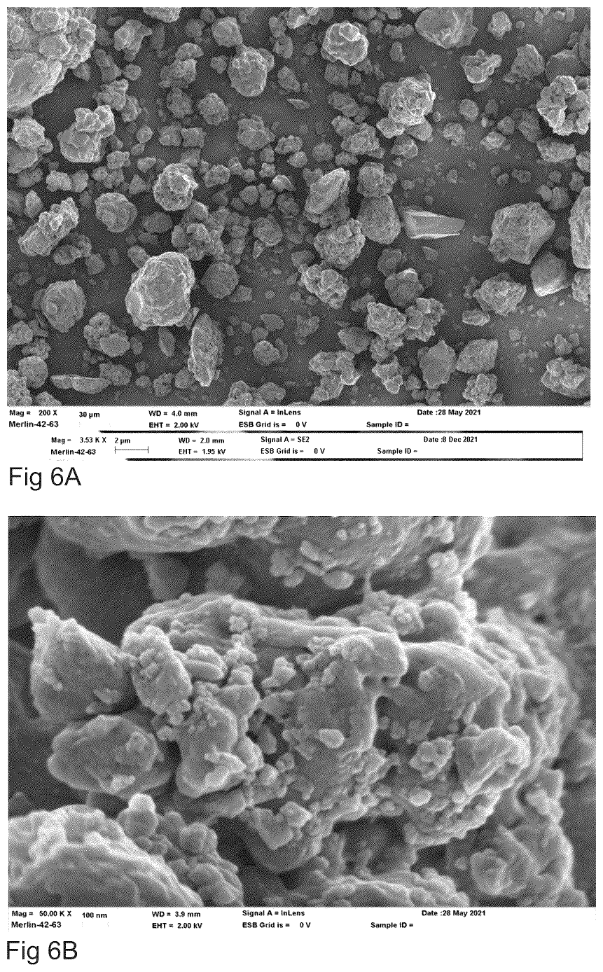

The lignin microparticles are preferably non-agglomerated, non-aggregates and/or non-fused. As can be seen for example from the FIGS. 4 and 5, the present lignin microparticles are substantially perfect spheres or spherical, which are not aggerated, agglomerated or fused. However the present spheres may not be perfect spheres but they may include natural variation in their shape, such as some of the microparticles may be slightly oblate, rounded, subrounded, angular and/or subangular so that they may include small depressions or inwards curved parts and/or the like imperfections. However the surface of the present spheres is even and/or smooth. When compared to non-spherical prior art kraft lignin microparticles, which are usually very angular, rough and/or uneven, such as shown in FIG. 6, the difference is clear, and it is also clear that the formation of spherical and separate lignin microparticles is not a result of prior art methods. The present microparticles may be specified as having a very high sphericity and roundness, preferably close to 1 each, such as 0.90 or more, for example 0.95 or more. Sphericity is a measure of how closely the shape of an object resembles that of a perfect sphere. Roundness is the measure of how closely the shape of an object approaches that of a mathematically perfect circle.

The lignin microparticles may be obtained from any suitable lignocellulosic material, such as hardwood, softwood or combinations thereof, or from bark or annual plants like straw. The different source materials have different chemical contents, which may have an impact to the formation and properties of the lignin microparticles, and/or other obtained materials.

The lignin microparticles, such as lignin microparticles obtained directly from the present preparation method, preferably do not substantially contain other substances, such as other polymeric and/or organic substances, for example cellulose and/or hemicellulose and/or substances based on these. However small amounts of such substances may be found as impurities. The obtained lignin microparticles can be also formed without other additional or added agents such as binders, inorganic and/or organic polymers, such as thermoplastic polymers, and/or fibers, fibrils, fillers, derivatizing agents, organic solvents, and/or the like, so preferably the lignin microparticles do not contain or substantially contain any of such agents or substances, and the preparation method does not include adding and/or using any of such agents or substances. However further products may be formed from the obtained lignin microparticles by adding such additives. In one example the lignin microparticles substantially consist of lignin. However minor amount/small quantities of inorganic substances may be included in the microparticles, such as sodium as discussed herein. The lignin in the microparticles may be also derivatized, such as containing phenolic OH groups.

### Application of the Lignin Microparticles

The obtained lignin microparticles have properties, which make them advantageous for a variety of applications. The small size, shape and lack of agglomeration of the microparticles provide properties such as high surface area, enhanced flowability, rheological properties, process and product controllability and the like. The microparticles have specific functionalities on their surfaces, and they can be further modified and/or derivatized. The lignin microparticles even tolerate extreme conditions, such as heat treatment at high temperatures and/or with high heating rate, and/or chemical modification. It is also possible to save costs in the preparation of the products, such as regents cost as the required amount of reagents are lower than conventionally, especially in the case of reference kraft lignin. Also a higher solid content of compositions or formulations can be achieved, and the solubility of the lignin microparticles in such products is good. Such compositions or formulations are easily applicable and do not pile up.

The lignin microparticles may be applied in a variety of uses and products, which may be in a form of a composition or a formulation comprising the lignin microparticles and/or microparticles derived from the lignin microparticles, and/or compositions or formulations containing thereof. The products may comprise one or more other substances such as one or more solvents and/or one or more binders, fillers, excipients, active agents and/or other agents, such as agents customarily used in the art. The lignin microparticles may act as binders, fillers, excipients or active agents, or may be derivatized to obtain such agents or functions.

The present disclosure provides a coating composition, a coating on a surface of an object, and a coated object comprising a coating on a surface thereof, the coating composition or the coating comprising and/or being obtained from the lignin microparticles disclosed herein. The coating compositions may be used to protect materials, such as wood, composites and the like, and it was noted that less coating required to obtain a good coverage compared to corresponding prior art coatings. The object may be a sheet or other shaped object of material, such as a (construction) board, strip, block, sheet or panel, or the like material which may be coated with the present coating.

The coating composition and/or the coating may be paint or other coating, which may be applied by any suitable means, such as by applying by brushing, by a paint roller, by spraying, by dipping and the like methods and means, which results in a formation of a coating. The coating composition comprises the lignin microparticles and may comprise one or more pigments or dyes, binders and/or other ingredients commonly or customarily used in the art, such as one or more polymers, which may be and/or be based on thermoplastic and/or thermosetting polymers, for example polyethyleneimine. The coating composition may be prepared by combining, such as mixing, the lignin microparticles with one or more of said ingredients, to obtain a composition in a solvent, such as an aqueous solvent. For example one or more of the ingredients may be provided as aqueous solution or dispersion.

The present disclosure provides use of spent pulping liquor for preparing the lignin microparticles and/or the further products disclosed herein.

The present disclosure provides use of the lignin microparticles disclosed herein for preparing products or in products, such as products disclosed herein.

The present disclosure provides use of the lignin microparticles disclosed herein for preparing a coating composition and/or for coating a surface of an object.

The present disclosure provides a resin comprising and/or obtained from the lignin microparticles disclosed herein. The lignin-based resins are fully or partly biobased resins, wherein the lignin microparticles are derivatized to obtain resins such as hemp-epoxy, lignin/poly(ethylene oxide), lignin/PVA, DL/epoxy, lignin/phenol formaldehyde, or fiber-reinforced composites. Examples of the lignin-based resins include phenolic resins, for example phenol formaldehyde resin, and epoxy resins. The lignin-based resins may be used in several applications, as such or in composites, for example in sports equipment, airplanes, boats, vehicles, and in construction components for buildings due to their lightweight, high specific modulus and strength. The lignin-based resins may be prepared by combining, such as mixing, the lignin microparticles with one or more of suitable agents to derive the lignin microparticles into a resin or into an ingredient of a resin. The lignin-based resins may be prepared by methods known in the art. The resins may be used in materials such as plywood, board, such as oriented strand board, laminated veneer lumber, laminated paper and/or insulation materials. These materials may contain wood, wood-derived or other natural materials.

The present disclosure provides use of the lignin microparticles disclosed herein for preparing a resin.

The present disclosure also provide UV protectors and fertilizers comprising and/or obtained from the lignin microparticles disclosed herein, and use of the lignin microparticles disclosed herein for preparing UV protectors and/or fertilizers. These products may be prepared with methods known in the art, and may include combining, such as mixing, the lignin microparticles with one or more of suitable other ingredients.

### Carbonization

The present disclosure provides carbonized lignin microparticles obtained from the lignin microparticles disclosed herein. The present disclosure provides use of the lignin microparticles disclosed herein for preparing carbonized lignin, such as carbonized lignin microparticles. The present disclosure provide use of the carbonized lignin microparticles for preparing products or in products, such as products disclosed herein.

The carbonization can be carried out by using any suitable carbonization process known in the art, especially processes and methods known for carbonizing lignin. However a significantly higher heating rate can be used for the present lignin microparticles.

The thermoplastic and fusing behaviour of lignin microparticles in general makes their thermal conversion into dispersed carbonized microparticles with controlled morphology and size highly challenging. Likewise, the injection and thermal conversion of thermally fusible lignin microparticles in the state-of-the-art thermochemical conversion reactors remains challenging due to lignin softening, melting, and swelling upon heating, which causes fouling and agglomeration problems.

Typically, excessively time-consuming thermal stabilization protocols are needed to cross-link the lignin structure, suppress its fusibility, and maintain its original morphological features during subsequent carbonization. For instance, an excessively long stabilization time by heating has been used for lignin microparticles at a very low heating rate of 0.01° C./min from ambient temperature up to 250° C., which represents more than 350 h of a thermal pre-treatment time Although the lignin microparticle thermoplastic behaviour was suppressed, the scalability of such a thermal stabilization method seems to be highly unpractical.

Kraft lignin thermal fusibility, foaming and agglomeration during heat treatment represents a major problem to its conversion into divided carbon materials with controlled morphologies. The fusing and foaming of kraft lignin microparticles during heat treatment results into a shapeless and foamed carbonized monolith with low accessible internal porosity and significantly low reactivity during subsequent physical activation. In addition, the injection of thermally fusible kraft lignin in thermochemical reactors remains a technological bottleneck hindering the upscaling of proper lignin thermal conversion technologies

Disclosed is a method for preparing spherical carbon microparticles from non-fusible kraft lignin microparticles obtained by the present membrane based lignin recovery method. The method has a main advantage of overcoming the fusibility of kraft lignins during heat treatment without the need for a compaction-crushing process, or a long thermal pre-treatment stage at temperatures in the range of 100-250° C. to stabilize the lignin particle morphology, which are carried out in prior art methods. The spherical carbon microparticles can be produced by a direct carbonization of lignin microparticles in the heating rate range of 1-10000° C./min, at temperatures in the range of 500-2000° C. Thus the process is fast and produces non-agglomerated carbonized lignin microparticles with controlled size and shape. The microparticles also have a controlled porosity and increased reactivity.

The present carbon microparticles can be separated from each other after a direct carbonization by gentle mechanical shearing. In addition, compared to the prior art carbonized kraft lignin fused microparticles, the present carbon microparticles have a much higher reactivity during subsequent physical activation in the temperature range of 650-1000° C., which allows a much better development of their internal porosity to produce high surface area carbon microparticles, using a less energy intensive process.

The present carbon microparticles, which may be also called as carbonized microspheres and/or carbonized lignin microparticles, have several advantages. They can be prepared in a simple process, which can be implemented as an industrial scale process, and which does not include pre or post treatment steps commonly used in the prior art carbonization processes. The present carbonization can be carried out as one step procedure when using the present lignin microparticles.

The carbonized microspheres have controlled size and morphology in contrast with fused and shapeless carbonized lignin microparticles from conventional lignoboost recovery.

There is no need for mechanical or thermal pre-treatment step to stabilize the lignin particle morphology. There is also no need for an additional mixing with an additive to stabilize the lignin particle morphology.

Therefore the carbonization may be carried out in the absence of a mechanical or thermal pre-treatment, such as a compaction-crushing process, and/or in the absence of an added stabilizing agent and/or thermal stabilization step.

The obtained carbonized lignin microparticles are thus preferably uncrushed, uncompacted and/or not stabilized with additional agents.

The present method enables more flexible carbonization technologies, including rotary furnaces, fluidized beds, or entrained flow reactors, to be used for a direct thermal conversion of the present lignin microparticles into carbonized microspheres.

The present method enables self-activation with lignin inherent Na-based catalysts during thermal treatment which creates an accessible porosity which can be further developed by physical activation. The present lignin based carbonized microspheres have high reactivity during physical activation compared to carbonized lignin from conventional recovery.

The flowability and injectability of the present carbonized lignin microparticles in thermal reactor is better compared to lignins from conventional recovery.

The electrochemical performance of the present carbonized lignin in electrochemical energy storage is also better compared to carbonized lignin from conventional recovery.

The lignin microparticles used in the carbonization may include sodium in lignin structure, such as bound to the lignin or in the form of free sodium carbonates. The sodium may be originated from the preparation process of the spherical lignin microparticles discussed herein.

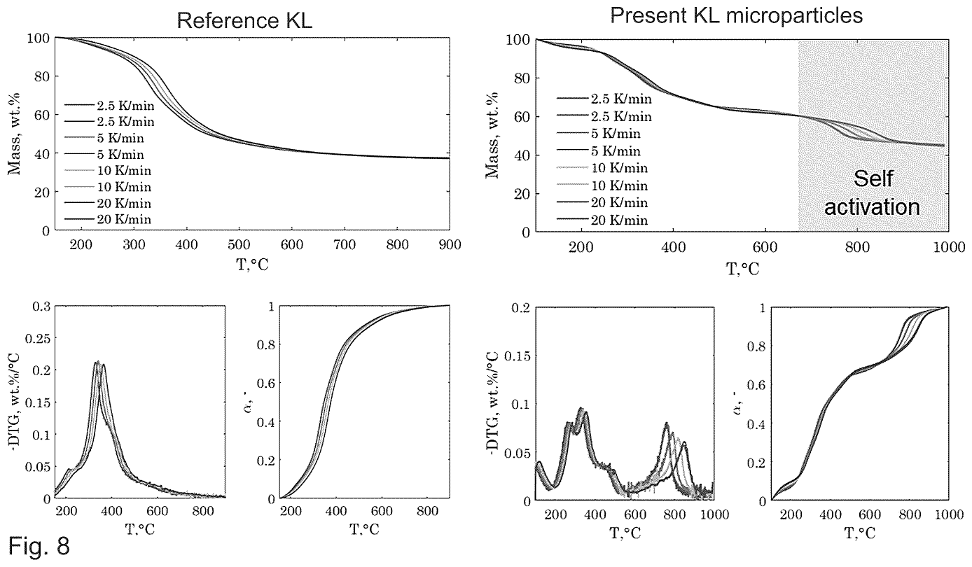

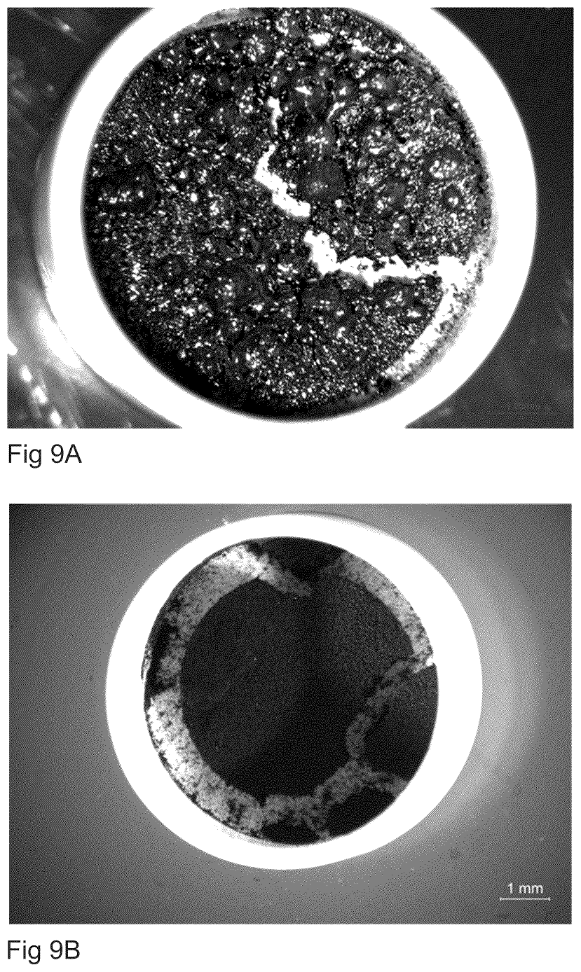

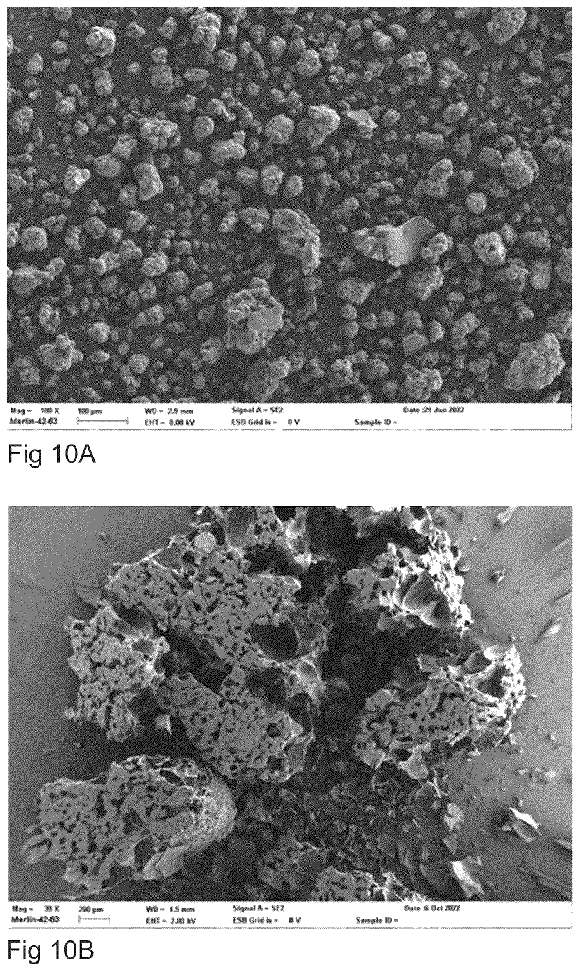

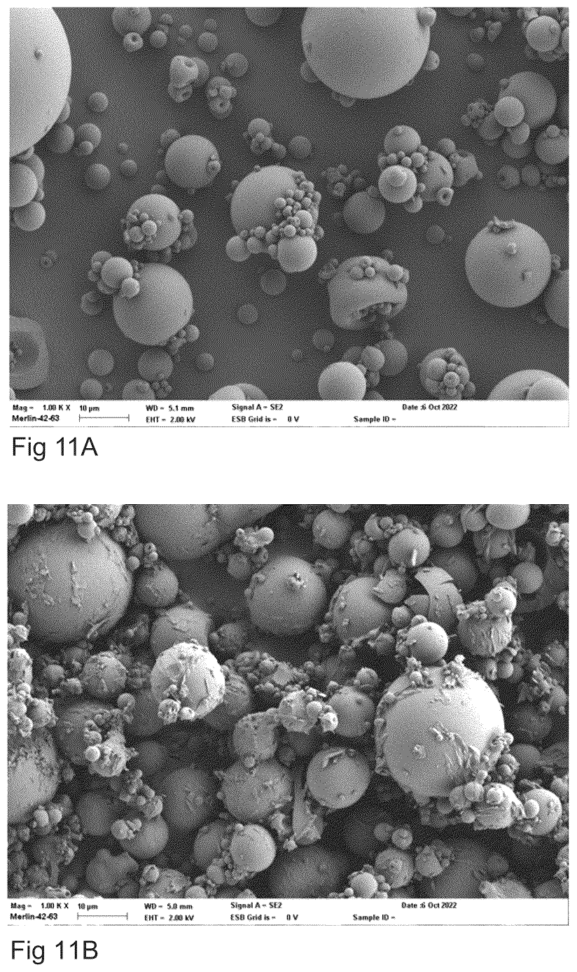

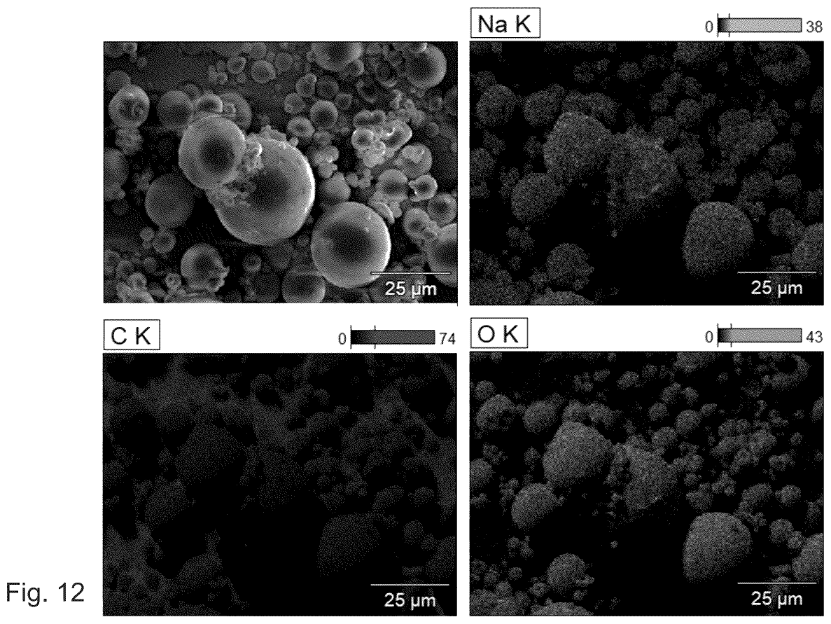

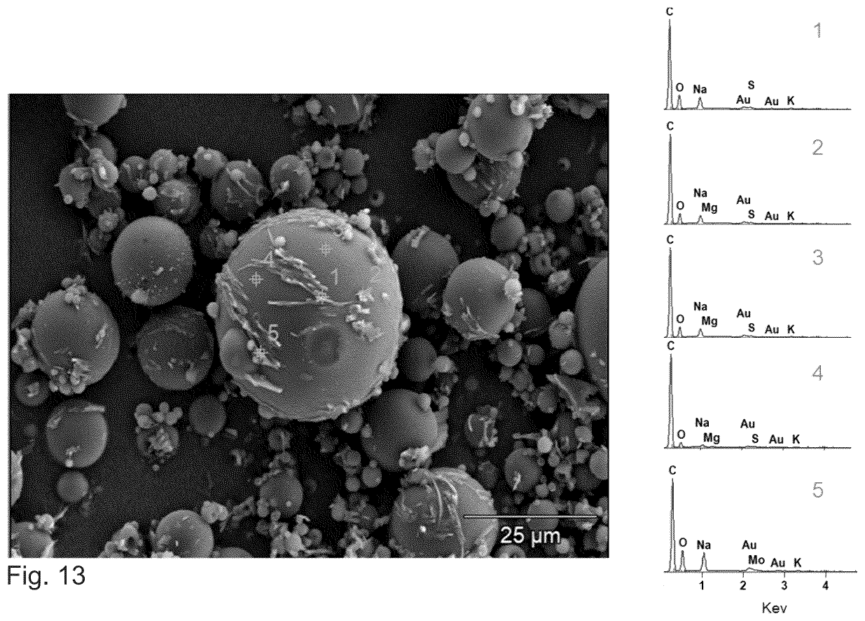

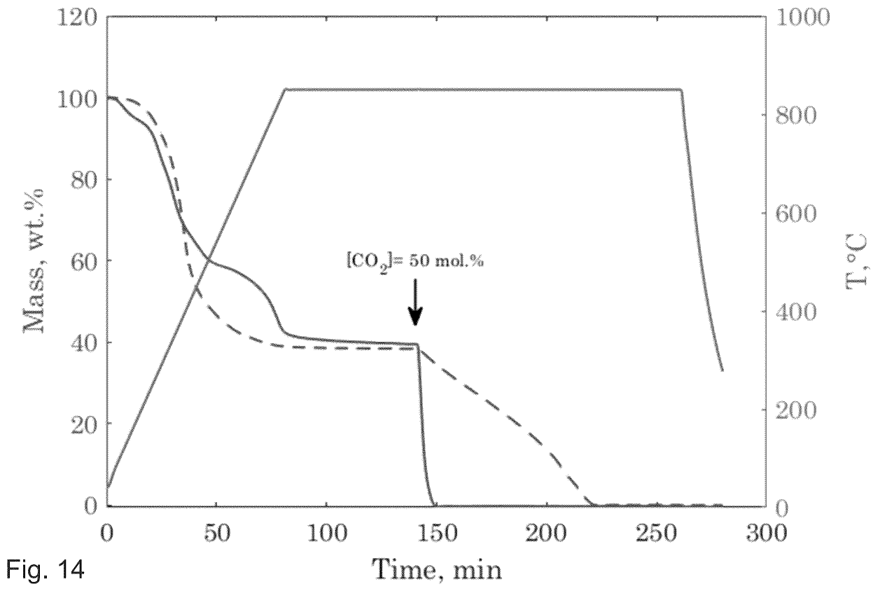

The retention of Na in the structure of the present dried lignin microparticles, whether bound to the lignin or in the form of free Na, reduces the thermal motion of lignin chains (no visible glass transition Tg) and prevents the fusing of the spherical lignin microparticles during the thermal treatment. Consequently, the morphology and size are retained during the heat treatment (see SEM images in FIG. 9, FIG. 10, and FIG. 11). The size and/or shape of the carbonized lignin microparticles may substantially correspond to the sizes and shapes specified for the lignin microparticles. In addition, the Na present in the lignin in the form of bound Na and/or sodium carbonate (see SEM-EDX image in FIG. 12) acts as a self-activating chemical at temperatures higher than 650° C. and creates an accessible porosity in the carbonized lignin microparticles (see the thermograms in FIG. 8). This open porosity facilitates the access of activating CO₂ gas to the internal porosity. The reactivity of the present carbonized lignin microparticles during physical activation becomes much higher than in the case of reference kraft lignin due to a combined effect of accessible porosity and catalytic activity of the remining Na oxide (see the SEM-EDX analysis in FIG. 13 and the thermograms in FIG. 14). The remaining Na can be acid-washed to separate it from the carbonized lignin microparticles. The obtained carbon microparticles can be used for example as carbon material in electrodes of electrochemical energy storage devices.

The electrochemical energy storage device may be a supercapacitor or a battery, such as lithium ion batteries or other applicable batteries. The carbonized lignin microparticles may be used as electrode material or in electrode of such device, for example to replace and/or support carbon materials conventionally used in the electrodes, such as to replace graphite used as anode material. The present disclosure provide use of the carbonized lignin microparticles as electrode material in electrochemical energy storage devices, or for preparing the electrochemical energy storage devices or parts thereof, such as electrode(s). The present disclosure also provides an electrochemical energy storage device comprising the carbonized lignin microparticles as electrode material. The carbonized lignin microparticles may be used as anode material.

In one embodiment the method comprises carbonizing the recovered lignin microparticles in a carbonization process by thermally treating the lignin microparticles at a carbonization temperature in the range of 500-2000° C., preferably in the range of 1000-1500° C. The heating rate may be in the range of 0.1-10000° C./min, preferably in the range of 0.5-100° C./min, such as 1-50° C./min, 10-100° C./min, 5-50° C./min or 5-15° C./min. The residence time at a final temperature may be in the range of 0.1-500 minutes, preferably in the range of 50-300 minutes. The final temperature refers to the carbonization temperature, which is reached after rising the temperature at a certain heating rate. The heating rate refers to heating rate used to achieve the final temperature.

The present disclosure provides a method for preparing carbonized lignin, the method comprising
providing the present lignin microparticles, preferably wherein majority of the lignin microparticles have a spherical shape and a diameter in the range of 1-50 μm, such as in the range of 1-20 μm, 2-10 μm or 2-8 μm, and preferably including sodium in lignin structure, such as bound to the lignin or in the form of free Na-carbonates, and
carbonizing the lignin microparticles in a carbonization process by thermally treating the lignin microparticles at a carbonization temperature in the range of 500-2000° C. with a heating rate in the range of 0.1-10000° C./min.

The carbonization temperature, which is the final temperature of the carbonization process, may be in the range of 1000-1500° C., such as in the range of 1200-1500° C. A subsequent physical activation at a temperature in the range of 650-1000° C. may be carried out, preferably in the presence of carbon dioxide.

The residence time at a final temperature may be in the range of 0.1-500 minutes, preferably 50-300 minutes. The carbonization, which may include the rise of temperature to the final temperature and/or the carbonization at the final temperature, may be carried out in inert atmosphere, such as argon or nitrogen. As no other method steps are required, the carbonization may consist of the disclosed method.

The present disclosure provides a method for improving electrochemical performance of the carbonized lignin microparticles used as anode material in batteries, such as Li-ion batteries. K-ion batteries and/or Na-ion batteries.

It was found that it is possible to improve the electrochemical performance of hard carbon microparticles derived from the KLMP through a simple intermediate catalytic pre-oxidation heat treatment and washing steps, before carbonization at temperatures above 900° C. The obtained hard carbon microparticles perform in par with commercial alternatives when used as anode material in Li-ion battery test cell. The washing can be carried out by acid solution, such as aqueous acid solution, or with (neutral) water or aqueous solution. The sodium removed from the material by the washing, preferably by (mild) acid washing, can be recycled back to the pulp mill, wherein the preparation of the lignin microparticles was carried out and/or which was the source of the lignin. Over 90% of the sodium could be removed/recovered/recycled. This increases the economic feasibility of the whole production process of lignin microparticles and hard carbon microparticles by minimizing the use and/or need of fresh sodium, which is typically added as NaOH make-up in the pulp mill. A mild or dilute acid was can be carried out, such as with sulfuric acid having a concentration of 5% or less.

The method for preparing carbonized lignin may comprise:
heating the lignin microparticles at an intermediate temperature ranging from 200° C. to 300° C. under an oxidative atmosphere to catalytically cross-link the structure of the lignin microparticles,
cooling the cross-linked lignin microparticles to room temperature and washing with acid solution to remove inorganics, such as with a dilute acid solution,
heat drying, such as oven drying, of the washed microparticles, and
carbonizing the lignin microparticles at a temperature of 900° C. or more, such as such as at 1200° C. or more, for example at a temperature in the range of 1200-1500° C., preferably to produce oxidized, cross-linked and/or high performance hard carbon microparticles. The oxidative atmosphere may comprise air or O₂ as oxidant. The washing produces sodium-rich washing water.

The method may be carried out at and/or in connection with a pulp mill, preferably which is the source of the lignin. The method may further comprise recycling the sodium-rich washing water obtained from the washing back to chemical recovery of a pulp mill to minimize the need of fresh NaOH in the pulp mill and to minimize changing, interfering and/or disturbing the Na/S balance of the pulp mill.

The obtained high performance hard carbon microparticles are especially suitable for battery applications. They exhibit specific textural properties and other properties, especially when carbonized at a temperature high enough, preferably at 1200° C. or more. The following are examples of the specific properties.

The carbonized lignin microparticles may have a micropore volume of 0.30 cm³/g or more, such as in the range of 0.30-0.50 cm³/g, determined by Dubinin-Radushkevich model.

The carbonized lignin microparticles may have a micropore area of 900 m²/g or more, such as 950 m²/g or more, for example in the range of 900-1200 m²/g, such as 950-1200 m²/g, determined by Dubinin-Radushkevich model.

The carbonized lignin microparticles may have a 2D-NLDFT micropore volume, of 0.330 cm³/g or more, such as 0.350 cm³/g or more, for example 0.330-0.400 cm³/g or 0.350-0.400 cm³/g.

The carbonized lignin microparticles may have a BET area of 850 m²/g or more, such as 880 m²/g or more, for example in the range of 850-1200 m²/g, 880-1200 m²/g or 880-1000 m²/g.

The carbonized lignin microparticles may have a C value of 3500 or more, such as 3800 or more, for example in the range of 3500-4500, 3500-4000 or 3800-4500, determined by BET.

The carbonized lignin microparticles may have a total pore volume of 0.40 cm³/g or more, such as 0.43 cm³/g or more, for example in the range of 0.40-0.80 cm³/g, or 0.40-0.60 cm³/g, determined by pore volume at P/P0=0.99.

The carbonized lignin microparticles may have an external area of 90 m²/g or more, such as 90-150 m²/g, for example 90-120 m²/g, determined by t plot.

The carbonized lignin microparticles may have a mesopore volume of 0.080 cm³/g or more, such as 0.085 cm³/g or more, for example in the range of 0.080-0.100 cm³/g, or 0.085-0.100 cm³/g, determined by difference VT-Vu.

The carbonized lignin microparticles may have a narrow micropore volume (<1 nm) of 0.300 cm³/g or more, such as 0.310 cm³/g or more, for example 0.300-0.400 cm³/g or 0.300-0.350 cm³/g.

The carbonized lignin particles exhibit increased delithiation capacity.

The carbonized lignin particles are hard carbons in powder form. No energy intensive grinding is needed to obtain the particles. The exhibit low share of fine particles in the carbon powder reducing handling risks

The present methods show fast catalytic cross-linking of the lignin structure and quantitative removal of inorganics.

### EXAMPLES

The percentages are by weight unless otherwise mentioned.

### Example 1: Preparation of Kraft Lignin Microparticles (KLMP)

Materials and methods:
Feed: Hardwood black liquor and Softwood black liquor
Membrane: NP010, 1 000-1200 Da, PES (MANN+HUMMEL)
Equipment: Shear induced cross-rotational (CR) membrane filter CR250 for lab scale tests.
   Two membrane sheets
   Total filtration area 0.09 m²
   Max pressure 10 bar
   Adjustments/measurements for pressures in and out, temperature, rotor speed, feed flow rate and flux
Filtration and washing with water at 55-60° C.

Filter CR250 and membrane NP010

OptiFilter CR250 filter (Valmet, Finland) with a maximum pressure of 10 bar. The cross-rotational filter created a high crossflow and turbulence on the membrane surface with special rotors leading to fouling reduction. In the OptiFilter CR 250 test unit there were two membranes with a total filtration area of 0.09 m² and between the membranes a rotor operated at 1000 rpm. The used rotation speed is down-scaled from the industrial scale equipment.

Studied ultrafiltration membrane was Nadir NP010 from MANN+HUMMEL, formerly Microdyn Nadir. NP010 is a polyethersulfone (PES) membrane that exhibits NF characteristics when exposed to high pressure. With a stabilized molecular weight cut-off (MWCO) in the range of 1000-1200 Daltons after operation at 40 bar (580 psi) and solute rejection of 35-75% Na₂SO₄, NP010 is a membrane that is stable in acid and caustic solutions.

### Materials Characterization

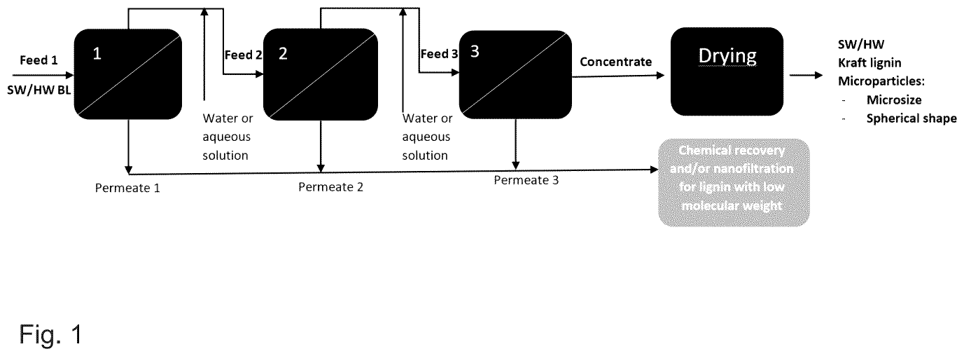

FIG. 1 shows an example of a process schema for the recovery of softwood (SW) or hardwood (HW) kraft lignin microparticles from black liquor (BL). Softwood (SW) black liquor with dry solids 42.2% and lignin content 14.8% was utilized for experiments. Hardwood (HW) black liquor with dry solids 20% and lignin content 6.4% was utilized for experiments.

SW black liquor demonstrated better yield than hardwood black liquor, however hardwood black liquor had different dry solids in the beginning that can effect on the results.

Lignin recovered from SW and HW black liquor have a spherical particle shape and size. Size of HW lignin microparticles is around 3.5-5 μm and up to 18 μm. Size of SW lignin microparticles is mainly 2-55 μm up to 105 μm. Particle size difference may be connected to initial BL concentration as well as higher carbohydrates content in HW black liquor in comparison with SW black liquor. Particle size was determined by scanning electron microscope (SEM).

The morphology of the lignin microparticles were analysed by a field emission scanning microscopy (SEM) with Zeiss Merlin FE-SEM instrument. Lignin microparticles containing concentrate was freeze-dried and/or spray-dried prior the analysis. For improving the secondary electron emission and electrical conduction, dried samples were coated by 2 nm of an ultra-thin coating of electrically conducting gold/platinum onto nanoparticles surface. 2 to 3 kV of high electron tension (EHT) was utilized in SEM analysis.

Particle size and distribution measurements were conducted in a Mastersizer 2000E (Malvern Instruments, Malvern, UK) using laser diffraction in liquid suspensions and having a dedicated software for calculating and outputting the results. The refractive index of the lignin microparticles was set to 1.61 and the absorption to 0.1. Results demonstrated in the Table 1 and FIG. 3 where it was determined that 10% of microparticles are below 2.4 μm and 50% below 9.9 μm and 90% below 96.7 μm.

TABLE 1

| | | | | Result in | Specific | | | |
|---|---|---|---|---|---|---|---|---|
| | Dx | Dx | Dx | range | surface | Concen- | | Weighted |
| Sample | (10) | (50) | (90) | (0.1-99.9) | area | tration | Residual | residual |
| name | (μm) | (μm) | (μm) | μm (%) | (m²/kg) | (%) | (%) | (%) |
| Reference | 9.08 | 336 | 693 | 10.41 | 65390 | 0.009 | 0.65 | 0.68 |
| KL (SW) | | | | | | | | |
| Lignin | 2.4 | 9.9 | 96.7 | 90.51 | 765200 | 0.007 | 0.54 | 0.94 |
| microparticles | | | | | | | | |
| (SW) | | | | | | | | |

As can be seen from the graph of FIG. 3A, conductivity (indicating ionic strength of the system and presence of small ionized molecules) decreased significantly during the membrane based lignin recovery process. Also pH decreased thus demonstrating removal of the alkaline ions as well as Na-ions from the concentrates to the permeate streams.

The lignin microparticles obtained with the present method and dried by spray drying are presented in FIGS. 4 and 5. FIG. 4 shows SEM images of hardwood kraft lignin microparticles recovered by membrane and dried by spray drying. The particle diameters determined from the microscopic images are in the range of 3.1-17.8 μm.

FIG. 5 shows SEM images of softwood kraft lignin microparticles recovered by membrane and dried by spray drying. The particle diameters determined from the microscopic images are in the range of 1.2-7.8 μm.

FIG. 6 shows SEM images of reference kraft lignin microparticles recovered by LignoBoost system. As can be seen from the from figures, the reference kraft lignin microparticles are not spherical and they tend to aggregate.

Functional groups in different lignin samples were analysed by NMR, and the results are shown in Table 2.

TABLE 2
³¹P NMR results on functional groups in lignin samples (mmol/g)

| | Aliphatic | Carboxylic | Condensed | | | p-OH- | Phenolic | Total |
|---|---|---|---|---|---|---|---|---|
| | OH | acid | PhOH | Guaiacyl | Catechols | phenyl | OH | OH |
| Reference | 1.72 ± 0.09 | 0.70 ± 0.01 | 1.29 ± 0.03 | 1.08 ± 0.00 | 0.66 ± 0.05 | 0.14 ± 0.02 | 3.17 ± 0.10 | 5.58 ± 0.20 |
| KL (SW) | | | | | | | | |
| Lignin | 2.39 ± 0.04 | 0.58 ± 0.02 | 1.29 ± 0.03 | 0.84 ± 0.00 | 0.50 ± 0.04 | 0.13 ± 0.00 | 2.76 ± 0.08 | 5.74 ± 0.13 |
| microparticles | | | | | | | | |
| (SW) | | | | | | | | |

Based on the results in Table 2, it indicates that reference SW kraft lignin and present SW kraft lignin microparticles have rather similar content of total phenolic OH groups. Kraft lignin microparticles have higher content of aliphatic OH groups, likely indicating the presence of carbohydrate based residues. Even if having rather similar characteristics regarding the phenolic content, the crucial difference in morphology between the reference kraft lignin and kraft lignin microparticles, is likely due to the different orientation of the lignin fragments during the recovery process leading to concentration of given functional groups in the surface of the lignin microparticles. Moreover, small particle size gives higher surface area contributing to high reactivity for present kraft lignin microparticles, in comparison with reference kraft lignin. The lignin microparticles also contain phenolate-bound sodium. Sodium (Na⁺) bound by the phenolic OH groups (existing as phenolates, PhO⁻ under the alkali conditions, pH>11) determined by P NMR (2.76 mmol/g) was computed to correspond to 7.7 wt % of lignin. The content is rather close to the measured Na-content, 8.41 wt % (Table 3) and indicates that majority of the Na-ions is bound to lignin instead of being so-called free Na.

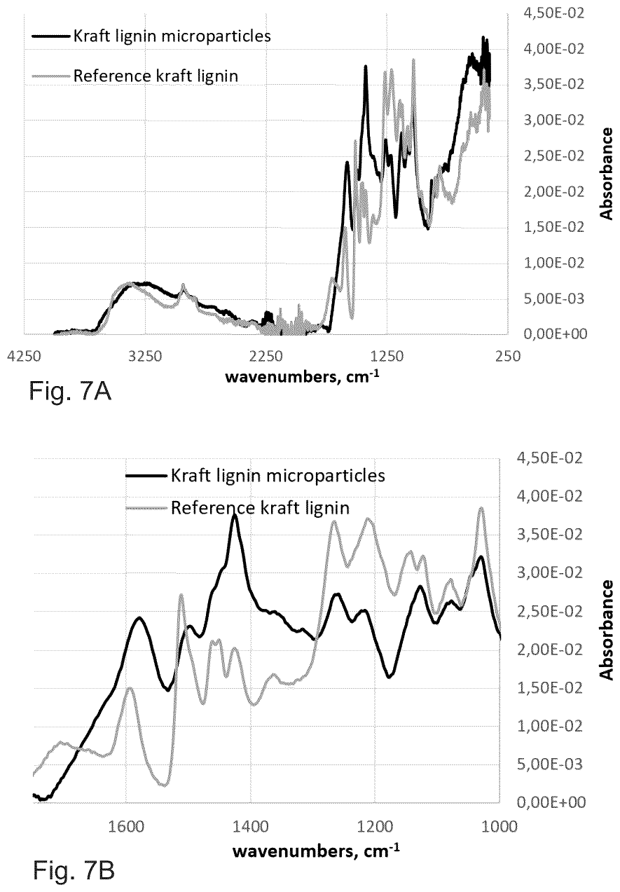

The FTIR spectres (FIG. 7A and B) also indicate the difference surface characteristics of the reference kraft lignin and kraft lignin microparticles. The kraft lignin microparticles have bands at around 1600-1550 cm⁻¹ and 1410 cm⁻¹ that correspond to sodium salt of carboxylic acids.

Content of metals, sulphur, and carbonate in the reference kraft lignin and kraft lignin microparticles are presented in Table 3. Na content in kraft lignin microparticles is much higher than in the case of reference kraft lignin. Also, carbonates (CO₃) are present in microparticles. Most parts of the Na and CO₃ are located in surface of the carbonized lignin microparticles (demonstrated in FIGS. 12 and 13, Na and O), while the reference kraft lignin does not contain these ions, and thus they are not present in the surface neither.

TABLE 3
Metals, sulphur, and carbonate in the lignin samples (% of dm).

| | | Reference | Kraft lignin |
|---|---|---|---|
| | | kraft lignin, % | microparticles, % of |
| Parameter | Method | of dm | dm |
| ICP-OES, Al | SCAN-N 38 | 0.01 | 0.01 |
| ICP-OES, Ca | SCAN-N 38 | 0.00 | 0.02 |
| ICP-OES, Cu | SCAN-N 38 | 0.00 | 0.00 |
| ICP-OES, Fe | SCAN-N 38 | 0.53 | 0.01 |
| ICP-OES, K | SCAN-N 38 | 0.05 | 0.51 |
| ICP-OES, Mg | SCAN-N 38 | 0.00 | 0.08 |
| ICP-OES, Mn | SCAN-N 38 | 0.00 | 0.01 |
| ICP-OES, Na | SCAN-N 38 | 0.20 | 8.41 |
| ICP-OES, S | SCAN-N 38 | 1.87 | 1.86 |
| ICP-OES, Si | SCAN-N 38 | 0.01 | 0.02 |
| CO3 | SCAN-N 32 | 0.00 | 3.69 |
| | | 2.7 | 14.6 |

### Application Testing

The microparticles were tested for different applications

### Coatings

The present recovered SW kraft lignin microparticles KL (MP) were tested for coatings, and were found suitable in coating applications. The present kraft lignin microparticles have improved processability thus providing better rheology of the solutions with KL (MP) vs KL. The solutions are more even, which makes them easier to apply. Also the ability of a hygroscopic material to resist the penetration of water determined by absorption test is better thus providing more stable coating. The ability of a hygroscopic material to resist the penetration of water. The present microparticles can be also used as antimicrobial additive in a formulation.

10 cm×10 cm spruce pieces were covered with the lignin-polyethylene imine (PEI) water-based solution with the target to have 75 g of coating formulation per m². Lignin: PEI ration is 70:30. Covered wooden block was dried at 100° C. for 60 min.

Coated wood block were kept in air-conditioned premises to reach equilibrium moisture. After it, water absorption test was applied.

### Lignin Solution Preparation.

12% lignin solutions were prepared by dissolving lignin KL (MP) in deionized water, solution was agitated overnight with magnetic stirrer. Conventional kraft lignin was dissolved in 1 M NaOH and agitated overnight with magnetic stirrer.

### Coating Formulation Preparation.

The specific method of preparation superhydrophobic lignin coatings is the following. 0.8 g of polyethylene imine (PEI) 2.8 g was added to 2.8 g of 12% lignin solution (KL or KL (MP)) and stirred for 15 min. The viscosity of the coating formulation was increasing with stirring time. At room temperature, the suspension was picked by the brush and applied to the wooden block. The wooden blocks were covered fully from one side. The wooden blocks were placed to an oven for 60 min at 100° C. After this the wooden blocks were left at an air-conditioned room for 1 week to reach moisture equilibrium. After 1 week an absorption test was carried out.

Absorption test was performed to follow coating resistance to the water. First, wooden block was weighted before the test (with coating applied). The glass with deionized water was placed on the top of the coated wooden brick. After 24 h, the coated wooden bricks were weighted to check the increase in the weight, indicating water absorption to the surface. Additionally, visual characteristic—such as coated surface quality after absorption test was applied.

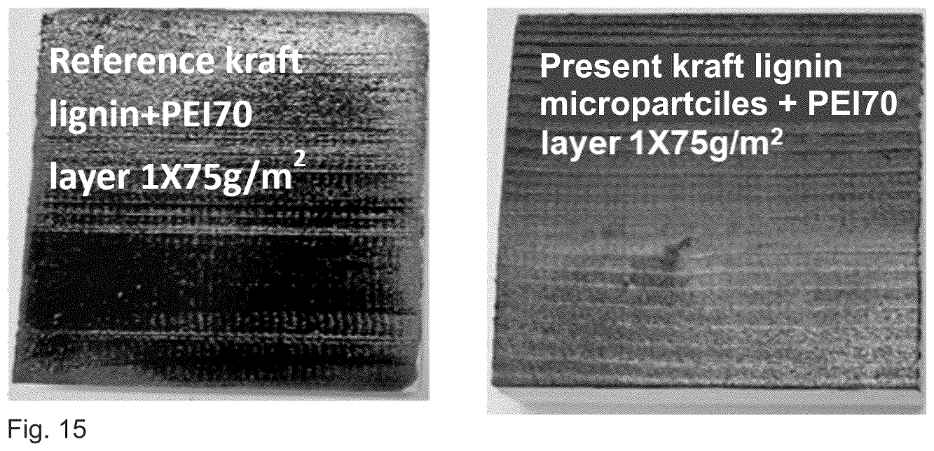

Mass of the wooden block coated with KL (MP) coating has increased only on 1.3% that demonstrated a good result in comparison with mass increase on 2.4% for non-treated surface and 1.7% for treated with reference kraft lignin. FIG. 15 shows wooden blocks coated with reference SW kraft lignin and the present SW kraft lignin microparticles.

### Resins

The KL (MP) was tested for the phenol-formaldehyde resins. It is know that lignin could be utilized as phenol replacement, however conventional reference lignin has limitations in the formulation. KL (MP) was tested against conventional lignin. One of the main drawbacks in lignin utilization as phenol replacements is low replacement rates due to high viscosity. Therefore, as one of the important parameters viscosity of the resin with KL (MP) vs KL was measured.

Additionally, KL (MP) does not require additional NaOH for solution preparation, water is enough, due to high alkalinity of KL (MP) in comparison with KL. Deionized water was utilized to prepare lignin solutions with KL (MP) and 1 M NaOH was utilized for preparation solutions with conventional KL.

This can provide savings in chemicals costs for resin production. KL (MP) demonstrate lower viscosity values at the same solid content and more stable solution in comparison with conventional KL. It was possible to increase the maximum solid content from 40 with reference lignin to 48% with the present kraft lignin microparticles.

Reference lignin was mixed with NaOH and water to reach solid content of 40% and pH 13. Solution was heated under continuous stirring for 2 h at 70° C. Visually it was detected that reference lignin solution was not liquid anymore and had very high viscosity as demonstrated in FIG. 16A (Conventional Kraft lignin, 2 h, 70° C., 40% ds).

The present SW kraft lignin microparticles were mixed with water to reach solid content of 40% and pH 13. No NaOH addition is required since KL (MP) lignin has bonded Na in the structure. Solution was heated under continuous stirring for 2 h at 70° C. Visually it was detected that the present SW kraft lignin microparticle solution was still liquid as demonstrated in FIG. 16B (2 h, 70° C., 40% ds).

### Resin Formulation

Phenol formaldehyde resins were performed in several steps:
1. 80% of the total water was placed to a beaker. Temperature was increased from 25 to 70° C.
2. Lignin was added and mixed for 5 min at 70° C.
3. In case of reference lignin NaOH was added to reach pH 10. The present SW kraft lignin microparticles demonstrated pH 11 without any NaOH addition. Additional mixing was carried out for 7 minutes.
4. The whole solution was mixed for 60 min at 70° C.
5. To keep pH over 10, NaOH was added to conventional KL. No NaOH was added to KL (MP) solution. Stirring and heating were carried out for additional 60 min at 70° C.
6. Formalin (37%) was added to the solution. Mixing 60+10 min and heating at 70° C. were carried out.
7. NaOH was added to keep pH 10 on case of conventional KL.
8. All phenol was added, pH was checked. The pH should be over 9.5, and shall be adjusted, if needed, by NaOH addition.
9. Cooking and mixing were carried out at 70° C. for 60 min
10. Temperature was increased from 70 to 90° C. 25 min of heating was carried out at 90° C.
11. The formulation was cooled down to room temperature and viscosity was analysed.

Reference lignin was added to the formulation at 34.2% of lignin content in the resin formulation. The viscosity at the end was 96 cP.

Reference lignin added to the formulation at 41.2% of lignin content was not dissolving properly at steps 1-9, moreover it piled up at the edges.

The present SW kraft lignin microparticles were added to the formulation at 33.8% of lignin content in the resin formulation. The viscosity at the end was 89.2 cP.

The present SW kraft lignin microparticles added to the formulation at 46.9% of lignin content was dissolving well during all the steps. However, the resin formulation was realtively thick.

As it is visible from the test results the present SW kraft lignin microparticles allow to increase lignin content in the resin formulation (and decrease phenol content respectively). Additionally, the present SW kraft lignin microparticles do not require addition of NaOH during resin preparation and in general, it is much more easy to process those lignins. The lignin was not piled up at the edges and had a good solubility. Moreover, non-dried SW KL (MP) concentrate could be utilized directly to phenol formaldehyde resin formulation. In this example, dried lignins were tested in order to have a clear comparison between the present SW KL (MP) and conventional KL.

### Carbonized Lignin Microparticles

The lignin microparticles prepared as discussed in previous were carbonized at 10° C./min up to 850° C. in argon and subsequently activated with CO₂ at the same temperature. Reference kraft lignin obtained by a prior art method was carbonized in the same way. The obtained carbonized lignin microparticles were analyzed and compared.

As can be seen from the SEM images in FIG. 9, FIG. 10, and FIG. 11, the morphology and size of the present lignin microparticles are retained during the heat treatment. FIG. 9 shows stereomicroscope images of the reference kraft lignin microparticles (9A) and the present kraft lignin microparticles (9B) after carbonization at 10° C./min up to 1000° C. FIG. 10 shows SEM images of reference KL microparticles before (10A) and after carbonization at 10° C./min up to 1000° C. (10B). FIG. 11 shows SEM images of the present KL microparticles before (11A) and after carbonization at 10° C./min up to 1000° C. (11B).

As can be seen in the SEM-EDX image in FIG. 12, which shows SEM-EDX images of the present KL microparticles showing the homogenous Na-dispersion (right top image), Na contained in the lignin in the form of bound Na and Na-salts acts as a self-activating chemical at temperatures higher than 650° C. and creates an accessible porosity in the carbonized lignin, as shown in the thermograms in FIG. 7. FIG. 7 shows mass loss, mass loss rate, and conversion level as a function of carbonization temperature for reference kraft lignin microparticles (left) and the present KL microparticles (right).

This open porosity facilitates the access of activating CO₂ gas to the internal porosity. The reactivity of the present carbonized KL microparticles during physical activation becomes much higher than the conventional KL due to a combined effect of accessible porosity and catalytic activity of the remining Na oxide, as shown in the SEM-EDX analysis in FIG. 13 and the thermograms in FIG. 14. FIG. 13 shows SEM-EDX point analysis of the present KL microparticles after carbonization showing surface agglomerates of Na-oxides.

FIG. 14 shows thermogravimetric mass loss as a function of time and temperature for prior art reference kraft lignin microparticles and the present microparticles after carbonization at 10° C./min up to 850° C. in argon and subsequent activation with CO₂ at the same temperature. The much higher reactivity of the present KL microparticles can be noted. Full conversion time was 8 minutes for the present KL microparticles, which is ten times faster than the full conversion time of 80 minutes reference kraft lignin microparticles (KL-SmL). This leads to considerable benefits in industrial scale operation of the carbonization process.

### Example 2: Activation of the Lignin Microparticles

In state of the art alkali-based chemical activation of organic materials into activated carbons (AC) requires high amount of chemical activator to achieve high surface area and high pore volume. The ratio of chemical activator to organic precursor is seldom lower than 1 if the goal is to produce AC with surface areas close or higher than 1000 m²/g.

In state of the art typically, Na-based alkalis (NaOH or Na₂CO₃) are mixed with an organic precursor and carbonized at temperatures in the range of 600-1000° C. The impregnation ratio (IR) defined as the mass of Na-alkali to the mass of organic precursor can be in the range of 1-8. High IRs can increase the AC production and post-treatment costs, which limit the technical and economic viability of the process.

Hayashi et al. (Hayashi, J., Kazehaya, A., Muroyama, K., & Watkinson, A. P. (2000). Preparation of activated carbon from lignin by chemical activation. Carbon, 38 (13), 1873-1878. https://doi.org/10.1016/S0008-6223 (00) 00027-0) prepared ACs from Kraft spruce wood lignin by chemical activation with K₂CO₃, Na₂CO₃, KOH, NaOH, ZnCl₂ and H₃PO₄. The KL was mixed with water and the activating agent (IR=1), and then kneaded. The mixture was then dried at 100° C. before the co-carbonization. The authors observed maximum surface areas at HTT=800° C. for both NaOH and Na₂CO₃.

Fierro et al. (Fierro, V., Torné-Fernández, V., & Celzard, A. (2007). Methodical study of the chemical activation of Kraft lignin with KOH and NaOH. Microporous and Mesoporous Materials, 101(3), 419-431. https://doi.org/10.1016/j.micromeso.2006.12.004) performed an extensive experimental study on the chemical activation of KL using NaOH and KOH, covering several variables, such as the activation temperature (HTT), hydroxide to lignin mass ratio (IR), activation time (At), flow rate of inert gas (FN2), and heating rate. The authors found that KOH leads to the most microporous ACs, having surface areas and micropore volumes typically 1.5 and 1.2 times higher than those obtained with NaOH. The lowest impregnation ratio they used is IR=1.

Torné-Fernandez et al. (Torné-Fernández, V., Mateo-Sanz, J. M., Montane, D., & Fierro, V. (2009). Statistical Optimization of the Synthesis of Highly Microporous Carbons by Chemical Activation of Kraft Lignin with NaOH. Journal of Chemical and Engineering Data, 54(8), 2216-2221. https://doi.org/10.1021/JE800827N) optimized the production of ACs from demineralized KL using NaOH activation following a statistical optimization approach based on DOE. The KL-to-total-mix mass ratios were between 18% and 32%, which corresponds to IR in the range of 2.1-4.5. The DOE variables were the HTT, the IR and the flow of nitrogen FN2. The authors produced mostly microporous carbons with apparent surface areas reaching 2610 m²/g. Based on the DOE model, the authors identified the optimal conditions to maximize the methylene blue adsorption as HTT=755° C., 22.4% Kraft lignin in the mixture, corresponding to IR=3.46, and FN2=200 ml/min.

Recently, Bergna et al. (Bergna, D., Varila, T., Romar, H., & Lassi, U. (2022). Activated carbon from hydrolysis lignin: Effect of activation method on carbon properties. Biomass and Bioenergy, 159, 106387. https://doi.org/10.1016/J.BIOMBIOE.2022.106387) tested different activation methods to produce ACs from hydrolysis lignin, including pretreatment with mineral acids (HCl, HNO₃, and H₃PO₄), followed by steam activation, as well as chemical activation with ZnCl₂, Na₂CO₃, and KOH. They reported a relatively low surface area (514 m²/g) after activation with Na₂CO₃ at 800° C. and IR=4.

The present example describes a simple and cost-efficient method to produce highly ultra-microporous activated carbon microspheres from the Kraft lignin microparticles (herein called KLMP or VTT-KLMP) recovered via the method described in the present application.

The method includes
slow carbonization of the KLMP, such as 5-20° C./min up to 1200-1500° C.
cooling of the activated carbon microparticles,
washing, if necessary, to remove remaining minerals, and
preferably recycling the sodium rich washing water back to pulp mill's chemical recovery to minimize the need of fresh NaOH in the mill and interviewing with the Na/S balance of the mill.

The obtained products are highly ultra-microporous activated carbon microspheres (ACM). The micropore volume of the ACM is ~0.346 cm³/g, and the micropore area is ~972 m²/g. The pore size distribution of the ACM shows a predominance of narrow micropores (<1 nm) with a peak at 0.56 nm. The pore volume of narrow micropores (<1 nm) estimated via the 2D-NLDFT is ~0.322 cm³/g, which represent nearly ~90% of the micropore volume. The ACM could be used for gas adsorption or gas purification (molecular sieves), as well as in electrochemical applications.

The initial highly dispersed state of the Na-based activating chemicals in the VTT-KLMP as well as the Na state in the lignin (phenolate vs mineral forms) makes possible to use a low ratio of activator/lignin (IR<0.25) compared to the state-of-the-art chemical activation protocols for which IR>1 (see Table 1).

The recovered KLMP has a high content of inorganics compared to commercial LignoBoost KL (see Table 4). The KLMP has high contents of Na (6.59-8.41 wt %) and carbonates (~3.69 wt %). Some of Na is present in organic form such as Na-phenolates, and some of it in mineral form such Na-carbonate, Na-hydroxide, and/or Na-sulphate. The total ash content in the KLMP is 23.38 wt %. The inorganic forms of Na, such as NaOH and Na₂CO₃, can act as chemical activators during high temperature carbonization, leading to the gasification of the carbon surface and the creation of porosity.

TABLE 4
Example of lignin chemical activation parameters and activated
carbon properties using Na-based activators.

| | | | | | | | | Carbon |
|---|---|---|---|---|---|---|---|---|
| | | | | | Yield, | SSA, | Vupores, | particles |
| Ref | Lignin | Activator | IR | HTT | wt. % | m²/g | cm³/g | morphology |
| The | SW KL | Na₂CO₃ + | ~0.2 | 1200 | 32 | 972 | 0.346 | microparticles |
| present | | NaOH + | | | | | | |
| work | | Na₂SO₄ | | | | | | |
| (Hayashi | spruce wood | Na₂CO₃ | 1 | 600 | — | 2 | 0.006 | — |
| et al., | KL | (solvent | | 700 | — | 195 | 0.082 | — |
| 2000a) | | mixing) | | 800 | — | 789 | 0.309 | — |
| | | | | 900 | — | 868 | 0.312 | — |
| | | NaOH | 1 | 600 | — | 690 | 0.278 | — |
| | | (solvent | | 700 | — | 987 | 0.399 | — |
| | | mixing) | | 800 | — | 1368 | 0.545 | — |
| | | | | 900 | — | 868 | 0.34 | — |
| (Fierro et | KL, | NaOH | 3 | 500 | 48.9 | 1435 | 0.49 | Aggregated |
| al., 2007) | demineralized | (granules, | | 600 | 42.7 | 1885 | 0.646 | blocks mostly |
| | by acid wash | mechanical | | 700 | 25.86 | 2397 | 0.937 | |
| | | mixing) | | 750 | 29.65 | 2307 | 0.793 | |
| | | | | 800 | 23.44 | 2384 | 0.784 | |
| | | | | 900 | 19.31 | 2051 | 0.706 | |
| | | | 1 | 700 | 39.31 | <500 | — | |
| | | | 2 | | 29.31 | 2256 | 0.84 | |
| | | | 3 | | 25.86 | 2397 | 0.937 | |
| | | | 3.5 | | 25.17 | 2461 | 0.859 | |
| | | | 4 | | 19.65 | 2051 | 0.812 | |
| | | | 5 | | 7.93 | 846 | 0.269 | |
| (Torné- | KL, | NaOH | 3.46 | 755 | — | 2612 | 1.112 | Aggregated |
| Fernández | demineralized | (granules, | | | (~25) | | | blocks mostly |
| et al., | by acid wash | mechanical | | | | | | |
| 2009) | | mixing) | | | | | | |
| (Bergna et | Softwood | Na₂CO₃ | 4 | 800 | 8.6 | 514 | 0.2275 | — |
| al., 2022) | hydrolysis | (Solvent | | | (82.1% | | | |
| | lignin | mixing) | | | carbon) | | | |

TABLE 5
Metals, sulphur, and carbonate in the lignin samples (% of dm).

| | | | | | KLMP |
|---|---|---|---|---|---|
| | | | | KLMP | After |
| | Reference | | | After | carbonization |
| | LignoBoost | KLMP | KLMP | carbonization | and washing |
| | KL | % of dm | % of dm | % of dm | % of dm |
| Parameter | % of dm | (Batch 1) | (Batch 2) | (Batch 2) | (Batch 2) |
| ICP-OES. | 0.01 | 0.01 | 0.0095 | 0.028 | 0.0268 |
| Al | | | | | |
| ICP-OES. | 0.00 | 0.02 | 0.02 | 0.0575 | 0.0261 |
| Ca | | | | | |
| ICP-OES. | 0.00 | 0.00 | 0.0003 | 0.00511 | 0.00713 |
| Cu | | | | | |
| ICP-OES. | 0.53 | 0.01 | 0.008 | 0.0239 | 0.0101 |
| Fe | | | | | |
| ICP-OES. | 0.05 | 0.51 | 0.547 | 1.19 | 0.0549 |
| K | | | | | |
| ICP-OES. | 0.00 | 0.08 | — | — | — |
| Mg | | | | | |
| ICP-OES. | 0.00 | 0.01 | 0.012 | 0.0404 | 0.0136 |
| Mn | | | | | |
| ICP-OES. | 0.20 | 8.41 | 6.59 | 0.797 | 0.0582 |
| Na | | | | | |
| ICP-OES. | 1.87 | 1.86 | 1.85 | 1.03 | 0.783 |
| S | | | | | |
| ICP-OES. | 0.01 | 0.02 | 0.016 | 0.0505 | 0.026 |
| Si | | | | | |
| CO₃ | 0.00 | 3.69 | — | — | — |

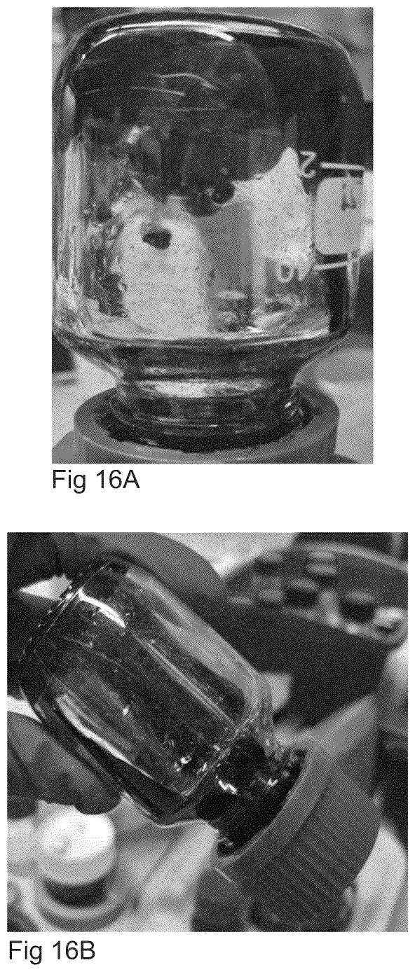

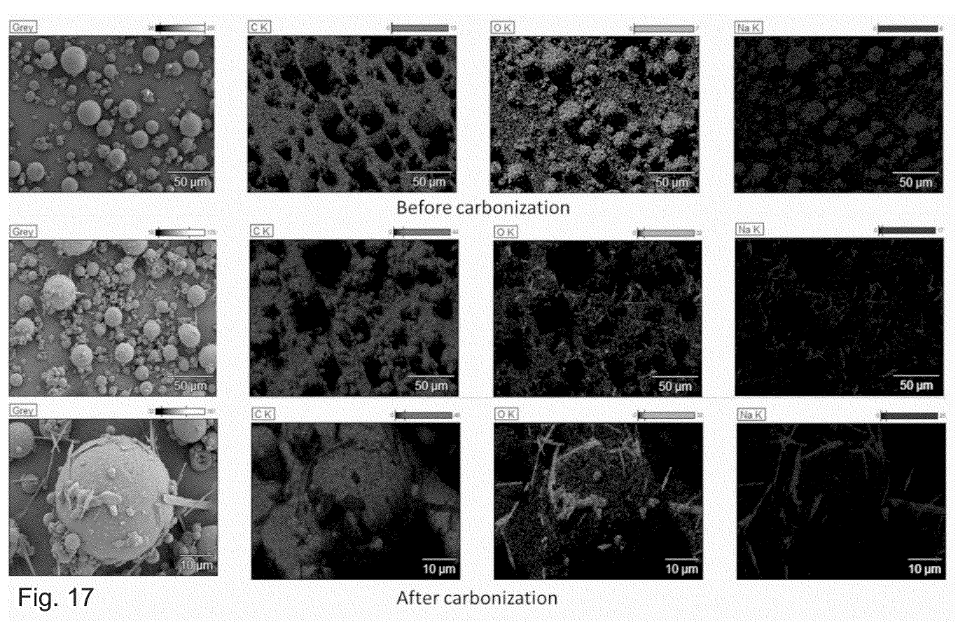

SEM-EDX (Scanning electron microscopy with energy-dispersive x-ray spectroscopy) elemental mapping shows the distribution of Na in the microparticles (see FIG. 17). Uniform distribution of Na is observed before carbonization, an attribute of the recovery process, where lignin slurry with inorganics is directly spray dried, resulting in an intimately mixed aerosol capable to self-assemble in form of microspheres.

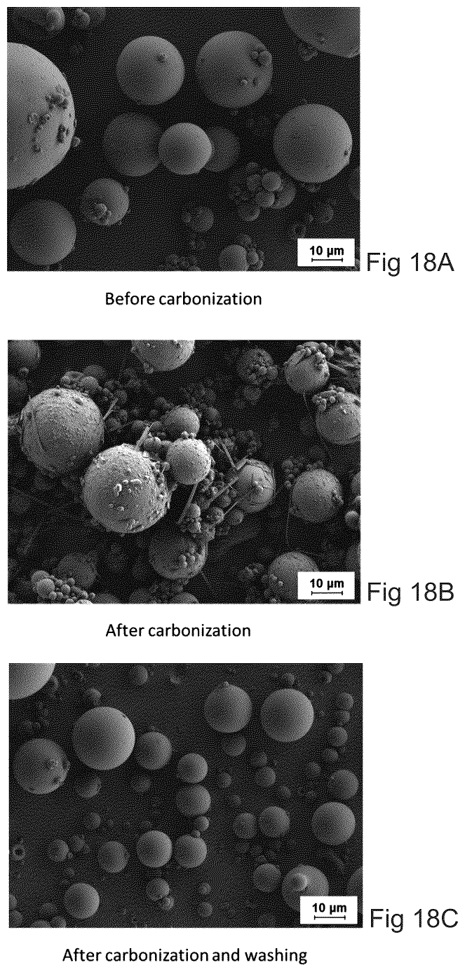

Upon carbonization, Na was observed to form new coarse particles outside the microparticles in form of Na₂O. This formation can be attributed to the decomposition of Na₂CO₃ at temperatures starting around 600° C. (see FIG. 18), leading to the generation of Na₂O and CO₂ homogeneously inside the carbonizing particle. The gaseous CO₂ can further reacts with the surface carbon atoms via the Boudouard reaction, leading to the production activation of sample and introduction of porosity. The finely dispersed Na in mineral and organic forms catalyses the gasification reactions and the formation of porosity.

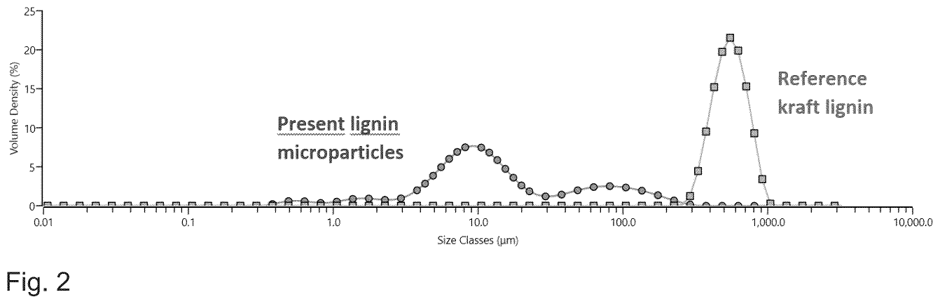

While the diffusion mechanism of Na during carbonization is not fully understood, there is evidence about the formation of Na-oxide particles in the form of stripes outside of the AC microparticles after carbonization (see FIG. 17). EDX mapping shows that those stripes are composed of Na and O (see FIG. 2).

The sodium oxide and other mineral components can be removed by means of facile diluted acid washing. SEM images of the washed carbon sample show smooth spherical particles and no Na could be detected using EDX (see FIG. 18). Those results are confirmed by the ICP-EOS analysis of the carbons before and after washing (see Table 4).

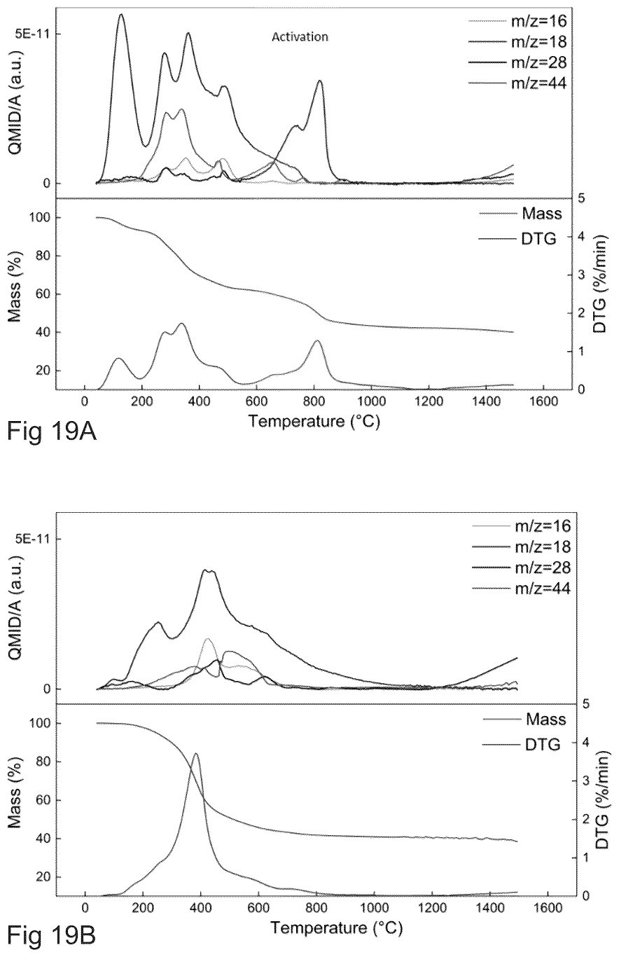

STA-MS analysis shows key thermal characteristics of present KL in contrast to commercial KL (see FIG. 19). The presence of inorganics, mainly in form of Na compounds induces high temperature gasification marked by a DTG peak having a maximum around 800° C., which is absent in the case of LignoBoost-KL. The high temperature DTG peak is accompanied by a similar shape CO peak (m/z=28), which further strengthen the hypothesis about chemical activation by Na-compounds and physical activation with CO₂.

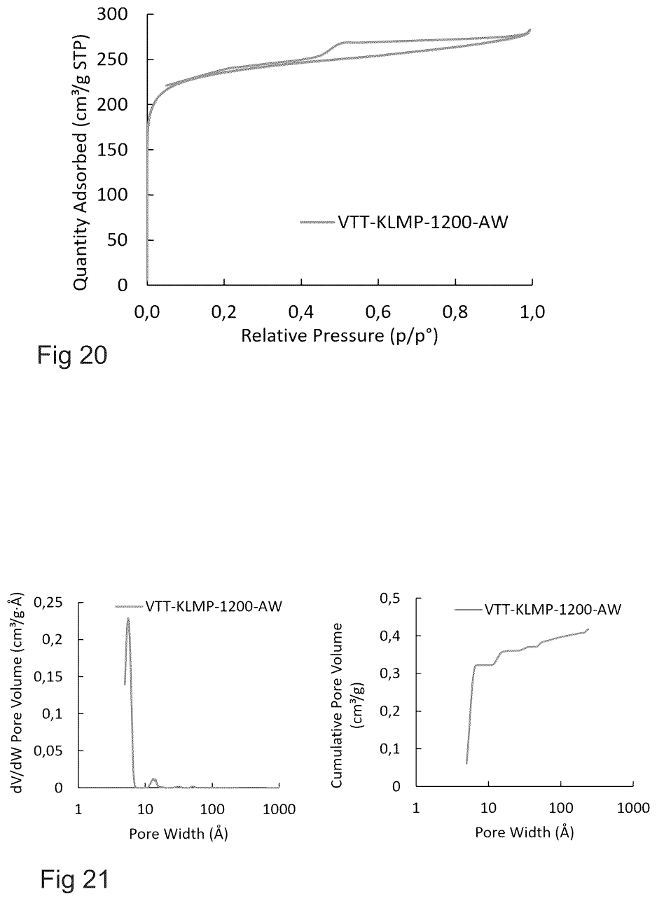

The obtained activated carbon displays a type IV isotherm in N₂ adsorption manometry (see FIG. 20).

The adsorption isotherm shows a highly predominant microporous texture, with a small share of mesopores evidenced by the presence of a hysteresis. The textural properties were calculated from the adsorption isotherm using different models and are shown in Table 6.

TABLE 6
Textural properties in the KLMP carbonized at 1200° C.

| Textural property | Value | Method |
|---|---|---|
| DR micropore area, m²/g | 972.44 | DR |
| DR micropore volume, cm³/g | 0.346 | DR |
| 2D-NLDFT micropore volume, | 0.361 | 2D NLDFT |
| cm³/g | | |
| BET area, m²/g | 894 | BET |
| C value | 3812 | BET |
| Total pore volume, cm³/g | 0.434 | Pore volume at |
| | | P/P0 = 0.99 |
| External area, m²/g | 92.6 | t plot |
| Mesopore volume, cm³/g | 0.088 | Difference VT − Vμ |
| Narrow micropore volume (<1 nm), | 0.322 | 2D NLDFT |
| cm³/g | | |

The total surface area calculated following the BET method is estimated at 894 m²/g. For highly microporous carbons, the Dubinin-Radushkevich model is a better alternative for the estimation of micropore volume and area. The DR micropore volume is estimated at 0.3459 cm³/g. and the DR micropore area at 972.4 m²/g.

The pore size distribution and cumulative pore volume (see FIG. 21) were calculated following the 2D-NLDFT model using N₂ adsorption on carbon slit-shaped pores (Jagiello & Olivier. 2013: 2D-NLDFT adsorption models for carbon slit-shaped pores with surface energetical heterogeneity and geometrical corrugation. Carbon, 55, 70-80. https://doi.org/10.1016/J.CARBON.2012.12.011).

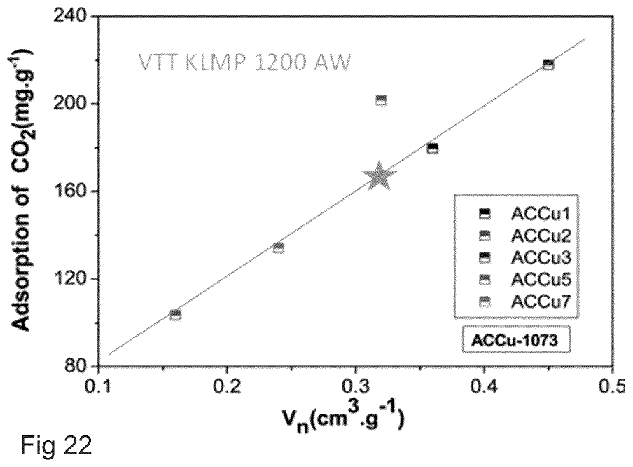

The pore size distribution shows a predominance of narrow micropores (<1 nm) with a peak at 0.56 nm. The pore volume of narrow micropores (<1 nm) estimated via the 2D-NLDFT is 0.322 cm³/g. which represent nearly 90% of the micropore volume estimated using the same method. This highly ultra microporous AC has good performance in CO₂ adsorption (see FIG. 22).

The experiments show lower chemical consumption compared to state-of-the-art chemical activation protocols. The obtained AC micro spherical particles have controlled size and morphology.

### Example 3: Improvement of Electrochemical Performance of Kraft Lignin-Derived Hard Carbon Microparticles Through Intermediate Catalytic Pre-Oxidation and Washing Steps

### State of the Art

Electrochemical performance of hard carbons used as battery anode materials can vary as a function of the hard carbon multiscale properties (morphology, texture, nanostructure, and surface chemistry). Hard carbon properties are correlated to electrochemical performance indices, such as the discharge capacity (DC) and the initial coulombic efficiency (ICE) and are influenced by the properties of the starting organic precursor, as well as the carbonization conditions (temperature, heating rate, pressure, etc). The composition and purity of organic precursors, such as lignins, can be modified by different kind of treatments, which alter the structure, the composition, or the purity of the starting material

Pre-treatments are also employed to control particle morphology during thermal conversion. Typically, excessively time-consuming thermal stabilization protocols are needed to cross-link lignin structure, suppress its fusibility, and maintain its original morphological features during subsequent carbonization.

The present example describes a method for fast catalytic oxidative cross-linking of inorganic-rich lignin microparticles at mild temperatures (200-300° C.), followed by a washing step to remove quantitatively the inorganic elements. The combination of the two steps preserves the micro spherical morphology and avoid catalytic gasification at high temperatures, which can lower the performance of the derived hard carbons.

### Short Description

Electrochemical performance of hard carbons used as battery anode materials can vary as a function of the hard carbon multiscale properties (morphology, texture, nanostructure, and surface chemistry). Hard carbons with low DC and/or low ICE have limited commercial use because of poor electrochemical performance indices. Those indices need to be maximized to increase the value and commercial applicability of a hard carbon.

The example describes a method to improve the electrochemical performance of the kraft lignin derived hard carbon, when used as anode material in Li-ion batteries. The Kraft lignin microparticles (KLMP or VTT-KLMP) are the lignin microparticles obtained with the method described in the present application.

It was found that it is possible to improve the electrochemical performance of hard carbon microparticles derived from the KLMP through a simple intermediate catalytic pre-oxidation heat treatment and washing steps, before carbonization at temperatures above 900° C. The obtained hard carbon microparticles perform in par with commercial alternatives when used as anode material in Li-ion battery test cell.

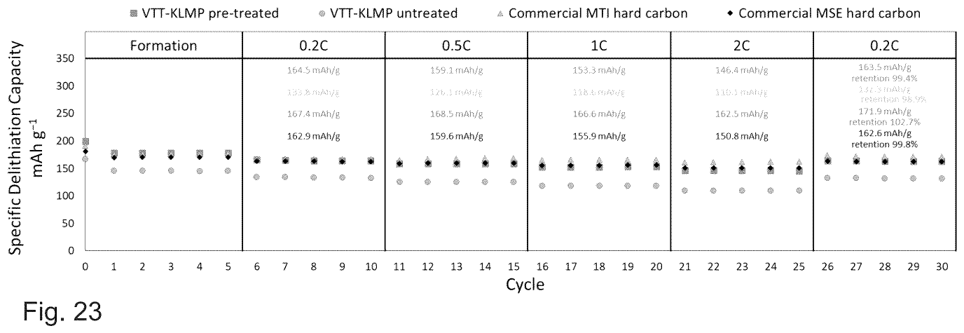

The KLMPs are first heated at intermediate temperature in the range of 200-300° C. under oxidative atmosphere to cross-link its structure. The mildly heat-treated lignin microparticles are then cooled to room temperature and washed with dilute acid solution to remove inorganics. The washed thermally treated lignin microparticles are then oven dried. After mild heat-treatment, washing, and drying, the lignin microparticles are carbonized at temperatures above 900° C. to produce higher performance hard carbon microparticles for battery applications (see FIG. 23).

The method includes:
heating lignin microparticles with a high inorganic content at an intermediate temperature ranging from 200° C. to 300° C. under an oxidative atmosphere to catalytically cross-link its structure,
cooling the cross-linked lignin microparticles to room temperature and washing with dilute acid solution to remove most of the inorganics,
oven drying of the washed microparticles, and
carbonization at temperatures above 900° C. to produce higher performance hard carbon microparticles for battery applications.

The specific delithiation capacity of the KLMP at 0.2C (cycle 30) increased from 132.3 mAh/g to 163.5 mAh/g with the pre-treatment, which represent an improvement of 24%. Through preliminary testing of general conditions, an electrochemical performance for the pre-treated sample was achieved that is in par with that of commercial hard carbons. Optimization of synthesis conditions could further enhance these results.

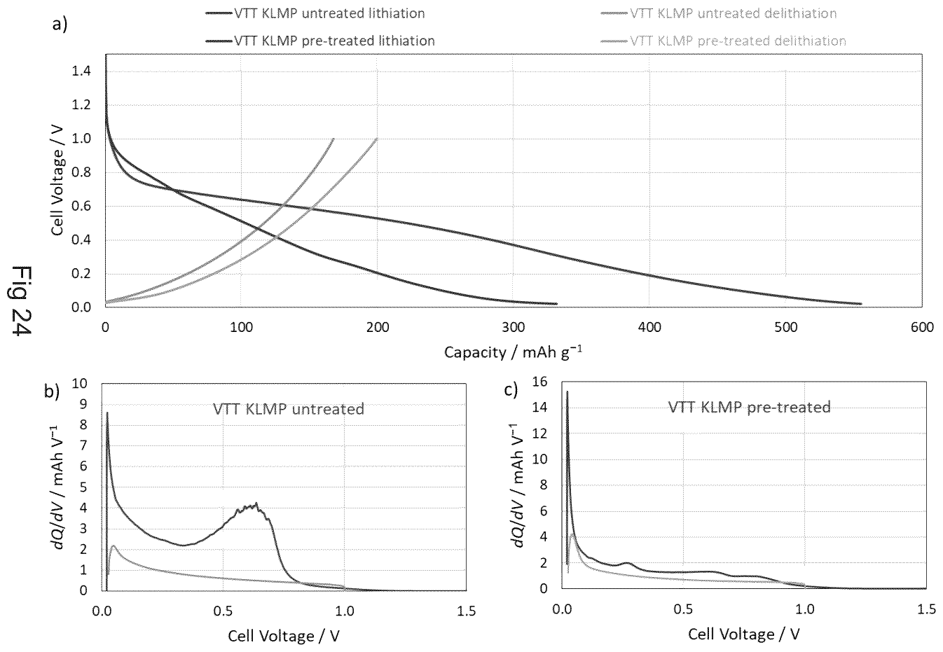

To further analyze the effect of the pre-treatment on battery performance, the lithiation/delithiation profiles of the first cycle are presented in FIG. 24. The directly carbonized material shows a lithiation plateau at 0.5 V-0.7 V (clearer in FIG. 24b) which is not visible in the pre-treated material. Since this plateau was not detectable in the delithiation profile, this charge is irreversible capacity, either formation of solid electrolyte interface or lithium intercalation in sites where the lithium cannot be reversible taken out. Mainly due to this plateau, the lithiation capacity of the first cycle is higher for the directly carbonized material. Additionally, the pre-treated material shows higher delithiation capacity, which seems to be mainly attributed to higher capacity at low potential which is the most valuable capacity in anode half-cells. Consequently, the pre-treatment increases the initial coulombic efficiency (delithiation capacity/lithiation capacity) from 30% to 60%.

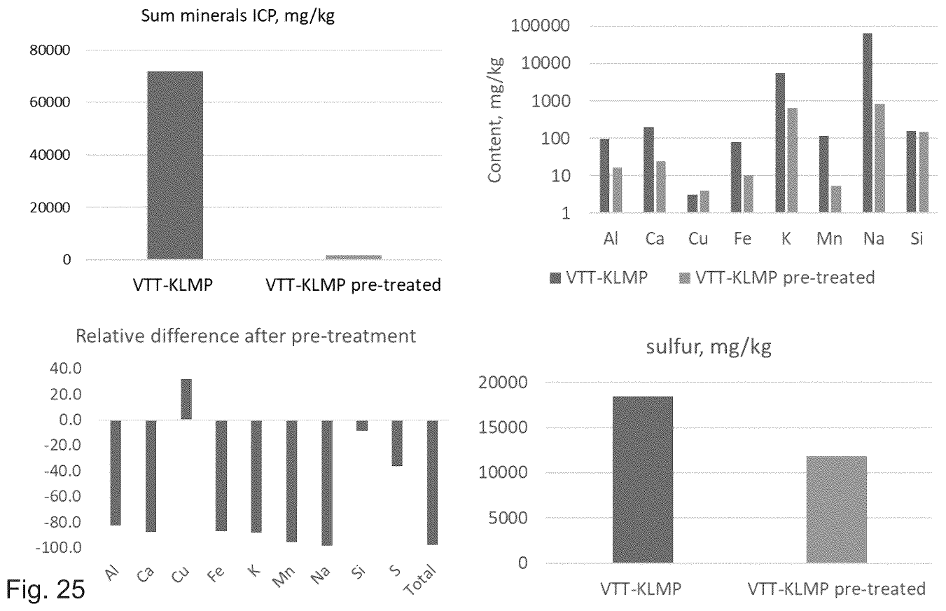

The intermediate preoxidation and washing steps resulted in an almost quantitative removal of most inorganic elements, except Cu and Si (see FIG. 25). The removal rates of alkaline and alkaline earth metal elements (AAEM), as well as Al, Fe, and Mn were higher than 80%. Cu was the most recalcitrant element, its content increased after pre-treatment due to removal of organic matter during mild heat treatment. Si is known to have low solubility in acidic solution. The sulfur content decreased as well in the pre-treated lignin, likely because of the preoxidation treatment which might lead to a release of gaseous sulfur compounds. Altogether, the sum of those elements decreased by close to 98%.

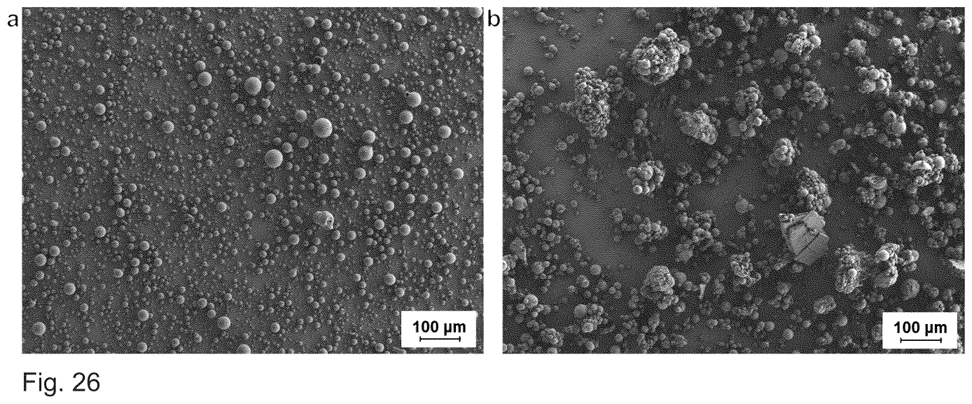

The micro spherical morphology of the pre-treated KLMP was partly retained during carbonization (see FIG. 26). Some particles were observed to fuse and form larger agglomerates. Nonetheless, the final product was an easily dispersible carbon powder.

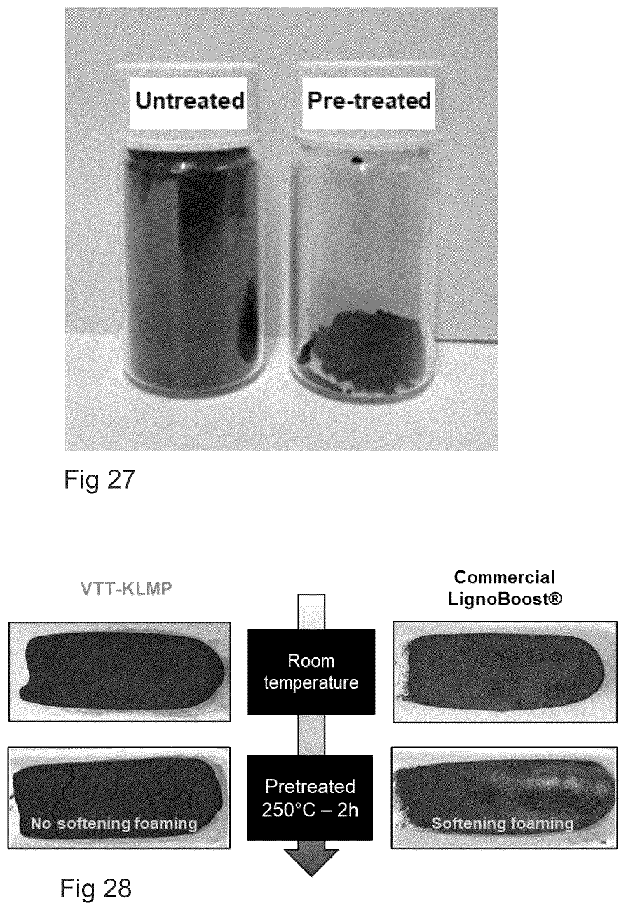

It was also observed that upon direct carbonization, the KLMP show a much higher proportion of fines compared to the pre-treated ones (see FIG. 27). Handling the pre-treated carbon powder would be easier, with lower risks related to fine powder inhalation or ignition.

Although most of the inorganics were removed after the pre-treatment, the pre-oxidized KLMP did not fuse extensively and retained a powder type consistency (see FIG. 28). In contrast the commercial LignoBoost® fuses and forms hard and agglomerated blocks upon carbonization. This indicates a significant advantage of the present KLMP which thermally stabilizes with a mild pre-oxidation step as compared to energy intensive procedures outlined in literature. Even though there is slight fusion after carbonization (FIG. 25), the powder consistency is maintained avoiding the need for additional mechanical processing, which is needed for the LignoBoost® kraft lignin for any use post carbonization.

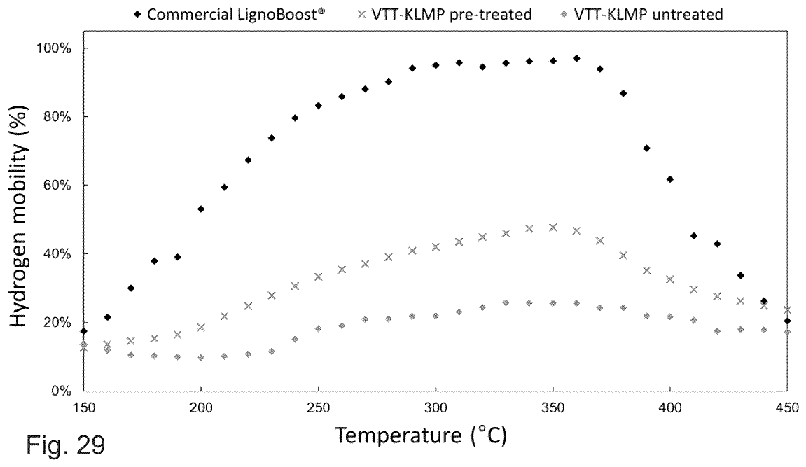

One of the explanations lies in the low thermal mobility of the lignin chains compared to a commercial LignoBoost® (see FIG. 29). Although the thermal mobility of the pre-treated KLMP was higher than the untreated one, it remained largely below of the commercial LignoBoost® lignin, which had a similar content of inorganics. The catalytic pre-oxidation step likely resulted in extensive cross-linking, which maintained a low thermal mobility and preserved the micro spherical morphology after washing and carbonization. The presence of inorganics could have catalyzed the oxygen cross linking reactions, making them fast enough to prevent any extensive mobility of the lignin chains compared to the case of LignoBoost® lignin.

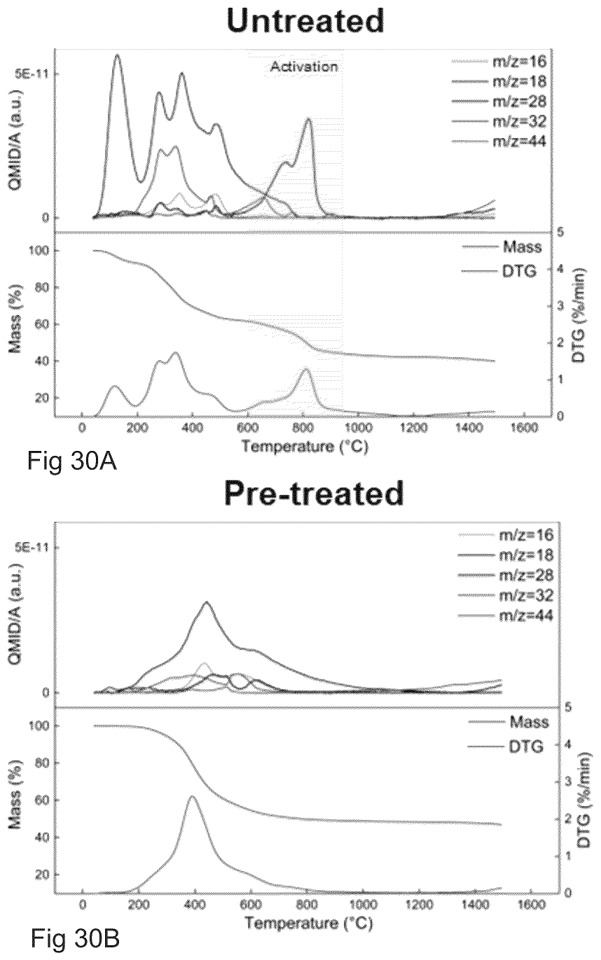

Simultaneous thermal analysis coupled with Mass Spectrometry (STA-MS) of pre-treated and untreated KLMP (FIGS. 30A, 30B) explains another aspect as to why the varied electrochemical activity is observed. Untreated KLMP shows release of carbon monoxide (CO) above 600° C. likely due to activation reactions by inorganics resulting in a porous material with high surface area. This activation is absent in the pretreated sample due to removal of inorganics during washing, as a result the micro spherical shape is retained as similar to untreated KLMP but without physical activation (low surface area).

Consequently, the first cycle irreversible capacity is significantly reduced for pre-treated KLMP sample (FIG. 24), translating into larger discharge capacity and better performance in Li-ion batteries (FIG. 23).

The following effects were demonstrated experimentally:
increased delithiation capacity of lignin-based hard carbon microparticles obtained using a lignin recovery technology described herein,
hard carbons are in powder form and no energy intensive grinding is needed,
fast catalytic cross-linking of the lignin structure and quantitative removal of inorganics and
lower share of fine particles in the carbon powder reducing handling risks.

1. A method for recovering lignin microparticles from spent pulping liquor, the method comprising
providing spent pulping liquor,
rejecting lignin from the spent pulping liquor with a membrane filter with a cut-off value in the range of 500-2000 Da to obtain a first concentrate comprising lignin and a permeate,
dispersing the first concentrate comprising lignin into water or aqueous solution to obtain a first dispersion,
rejecting lignin microparticles from the first dispersion with a membrane filter having a cut-off value in the range of 500-2000 Da to obtain a second concentrate comprising lignin microparticles and a permeate,
recovering the lignin microparticles
wherein
at least 50% by volume of the lignin microparticles are non-fused, and have a spherical shape and a diameter in the range of 1-50 μm, determined by scanning electron microscopy (SEM) and/or by laser diffraction.

2. The method of claim 1, comprising
dispersing the second concentrate comprising lignin microparticles in water or aqueous solution to obtain a second dispersion,
rejecting lignin microparticles from the second dispersion with a membrane filter having a cut-off value in the range of 500-2000 Da to obtain a third concentrate comprising lignin microparticles and a permeate,
recovering the lignin microparticles from the third concentrate.

3. The method of claim 1, comprising drying the recovered lignin microparticles.

4. The method of claim 1, comprising recovering the lignin microparticles by spray-drying.

5. (canceled)

6. The method of claim 1, wherein the dispersing is carried out to obtain a dispersion with substantially equal volume to the volume of the black liquor before filtering.

7. The method of claim 1, comprising carrying out the method without precipitation of lignin without hydrolysis of lignin; without enzymatic digestion of lignin; without emulsion solvent evaporation; without chemical derivatization of lignin with added chemical; without depolymerization of the recovered lignin and/or without carbonizing the lignin particles.

8. Lignin microparticles, wherein at least 50% by volume of the lignin microparticles are non-fused, and have a spherical shape and a diameter in the range of 1-50 μm determined by scanning electron microscopy (SEM) and/or by laser diffraction.

9. The lignin microparticles of claim 8, wherein the percentile particle diameter distribution, determined by laser diffraction, comprises D₁₀ in the range of 2-3 μm, D₅₀ in the range of 5-15 μm and/or D₉₀ in the range of 90-100 μm.

10. The lignin microparticles of claim 8, comprising sodium bound to lignin via phenolic groups.

11. The lignin microparticles of claim 8, comprising 2.0 mmol/g or more aliphatic OH groups determined by ³¹P NMR.

12. The lignin microparticles of claim 8, wherein the lignin microparticles are unprecipitated with additional agents, not obtained by emulsion solvent evaporation, non-agglomerated, unhydrolyzed, enzymatically undigested, uncarbonized, underivatized, uncompacted and/or uncrushed.

13-14. (canceled)

15. Lignin microparticles obtained with the method of claim 1, wherein at least 50% by volume of the lignin microparticles are non-fused, and have a spherical shape and a diameter in the range of 1-50 μm determined by scanning electron microscopy (SEM) and/or by laser diffraction.

16. A method for preparing carbonized lignin, the method comprising
providing lignin microparticles of claim 8,
carbonizing the lignin microparticles in a carbonization process by thermally treating the lignin microparticles at a carbonization temperature in the range of 500-2000° C. with a heating rate in the range of 0.1-10000° C./min.

17. The method of claim 16, comprising
heating the lignin microparticles at an intermediate temperature ranging from 200° C. to 300° C. under an oxidative atmosphere to catalytically cross-link the structure of the lignin microparticles,
cooling the cross-linked lignin microparticles to room temperature and washing with acid solution to remove inorganics,
heat drying of the washed microparticles, and
carbonizing the lignin microparticles at a temperature of 900° C. or more.

18. (canceled)

19. A coating composition comprising the lignin microparticles of claim 8.

20. A resin comprising or obtained from the lignin microparticles of claim 8.

21. Carbonized lignin microparticles obtained from the lignin microparticles of claim 8.

22. The carbonized lignin microparticles of claim 21 having a micropore volume in the range of 0.30-0.50 cm³/g determined by Dubinin-Radushkevich model.

23. The carbonized lignin microparticles of claim 21 having a micropore area in the range of 900-1200 m²/g determined by Dubinin-Radushkevich model.

24. An electrochemical energy storage device comprising the carbonized lignin microparticles of claim 21 as electrode material.

25-28. (canceled)
